(19) United States
(12) Patent Application Publication
(10) Pub. No.: US 2011/0029622 A1
(43) Pub. Date: Feb. 3, 2011

(54) SYSTEMS AND METHODS FOR GROUP COMMUNICATIONS

(76) Inventors: Jay S. Walker, Ridgefield, CT (US); Lisa H. Shufro, Stamford, CT (US); Jordan M. Masarek, Weston, CT (US); Nikita S. Dyer, Shanghai (CN)

Correspondence Address: WALKER DIGITAL MANAGEMENT, LLC, 2 HIGH RIDGE PARK, STAMFORD, CT, 06905, US

(21) Appl. No.: 12/823,118

(22) Filed: Jun. 24, 2010

Related U.S. Application Data
(60) Provisional application No. 61/220,105, filed on Jun. 24, 2009.
(60) Provisional application No. 61/247,737, filed on Oct. 1, 2009.
(60) Provisional application No. 61/267,002, filed on Dec. 4, 2009.
(60) Provisional application No. 61/337,688, filed on Feb. 8, 2010.

(51) Int. Cl. G06F 15/16

(52) U.S. Cl. 709/206

(57) ABSTRACT

Systems, apparatus, methods, and articles of manufacture for group communications.

### CROSS-REFERENCE TO RELATED APPLICATIONS

The present application claims benefit and priority under 35 U.S.C. §119(e) to:

(i) U.S. Provisional Patent Application Ser. No. 61/220,105 filed Jun. 24, 2009, and entitled “SYSTEM AND METHOD FOR NETWORK-BASED POLLING OF THE AVAILABILITY AND STATUS OF A GROUP OF PEOPLE”;

(ii) U.S. Provisional Application No. 61/247,737 filed Oct. 1, 2009, and entitled “SYSTEM AND METHOD FOR NETWORK-BASED POLLING OF THE AVAILABILITY AND STATUS OF A GROUP OF PEOPLE”;

(iii) U.S. Provisional Application No. 61/267,002 filed Dec. 4, 2009, and entitled “SYSTEM AND METHOD FOR NETWORK-BASED POLLING OF THE AVAILABILITY AND STATUS OF A GROUP OF PEOPLE”; and

(iv) U.S. Provisional Application No. 61/337,688 filed Feb. 8, 2010, and entitled “SYSTEM AND METHOD FOR NETWORK-BASED POLLING OF THE AVAILABILITY AND STATUS OF A GROUP OF PEOPLE”.

Each of the above-identified applications is hereby incorporated by reference herein in its entirety.

### BACKGROUND

With the increased availability and utilization of mobile communications devices as well as other devices utilizing many types of communication mediums, communications between, amongst, and associated with groups of individuals are becoming more prevalent. Existing systems and methods of group communications, however, fail to provide various benefits such as those that may be realized by implementation of embodiments described herein.

### BRIEF DESCRIPTION OF THE DRAWINGS

An understanding of embodiments described herein and many of the attendant advantages thereof may be readily obtained by reference to the following detailed description when considered with the accompanying drawings, wherein:

FIG. 1 is a block diagram of a system according to some embodiments;

FIG. 2 is a block-flow diagram of a system process according to some embodiments;

FIG. 3 is a block diagram of a system according to some embodiments;

FIG. 4 is a block-flow diagram of a system process according to some embodiments;

FIG. 5 is a block-flow diagram of a system process according to some embodiments;

FIG. 6A and FIG. 6B are block diagrams of an exemplary interface structure according to some embodiments;

FIG. 7 is a flow diagram of a method according to some embodiments;

FIG. 8 is a flow diagram of a method according to some embodiments;

FIG. 9 is a flow diagram of a method according to some embodiments; and

FIG. 10 is a block diagram of an apparatus according to some embodiments;

### DETAILED DESCRIPTION

### I. Introduction

Some embodiments described herein facilitate simplification of the process of sending a message (such as a text message sent in accordance with the Short Message Service (SMS) and/or the Multimedia Messaging Service (MMS) protocols) to a group, managing multiple responses from the group, and distributing a follow up to the original message. Some embodiments may also facilitate the creation, tracking and administration of message exchanges—such as SMS, MMS, e-mails, instant messages, voice messages, etc., between a group of people, the a coordinator of the group, and/or in some embodiments, one or more people outside of the group.

For exemplary purposes of illustration only, following are two categories of use that may be associated with embodiments described herein.

The first category may comprise a group formed largely for informal social interaction, such as coordinating plans, finding the first person out of a group who knows the answer to a particular question, or checking in with a group of people to test their time and/or emotional availability (e.g., before a voice call is placed to a particular individual).

The second category may comprise a group organizing around a more formal and ongoing purpose. The purpose may be to influence the behavior of a particular member of that group, such as complying with medical prescriptions or other health regimens. For example, a prescription drug user who consciously or subconsciously strays from adherence to a prescribed medical regimen can be supported by a group of people working together to help keep the user (or “target”) on track. One person from the group may be designated as the group's coordinator who uses a software application designed to schedule and track periodic support calls from members of the group to the target.

Some embodiments may be directed to utilization of a controller to manage group communications. Embodiments may comprise, for example, receiving an indication of a request to transmit a message to a group, distributing (e.g., in response to the receiving of the indication of the request to transmit the message to the group) the message to the group, wherein the group comprises a plurality of members. Embodiments may further comprise, receiving (e.g., after the distributing of the message to the group) a plurality of responses to the message, generating a status report message, wherein the status report message comprises information summarizing the received plurality of responses to the message, and transmitting the generated status report message.

According to some embodiments, group communications may be scheduled and/or may be automatically managed by a controller. Embodiments may comprise, for example, receiving an indication of a request to schedule recurring communications between a recipient and a group, wherein the group comprises a plurality of members, determining (e.g., in response to the receiving of the indication of the request to schedule recurring communications between the recipient and the group) a schedule defining when each member of the group is responsible for communicating with the recipient, determining (e.g., based on a current time and the schedule) which group member is next responsible for communicating with the recipient, transmitting (e.g., in response to the determining of which group member is next responsible for communicating with the recipient), to the determined responsible group member, a reminder to communicate with the recipient during the next scheduled time, and determining (e.g., after the transmitting of the reminder to communicate with the recipient during the next scheduled time) whether the determined responsible group member has communicated with the recipient as scheduled.

### II. Terns and Definitions

As utilized herein, the term “group” may generally refer to any sortable, delineated, ad-hoc, formal, informal, and/or otherwise identifiable plurality of individuals, entities, and/or devices (and/or devices operated by individuals and/or entities). As an example, a group can be set up ad-hoc for a one time purpose or can be a permanent group set up for a persistent purpose. In some embodiments, a “support group” may comprise a group of people that participate in the various embodiments described herein and/or communicate around a specific purpose (e.g., that may be designated by a coordinator of the group) such as, but not limited to, determining availability of group members, answering questions and/or surveys (e.g., polling), and/or completing tasks (e.g., calling a family member to remind them to take their medication).

As utilized herein, the terms “group coordinator” or “coordinator” may be utilized interchangeably and may generally refer to any individual and/or entity (e.g., a plurality of individuals) that is responsible for and/or otherwise associated with organizing, defining, and/or managing a group. The group coordinator may, for example, organize the other members around a purpose (e.g., organizing calls to a group target, planning an event, requesting communication with one or more members, etc.).

Also as utilized herein, the term “group member” may generally refer to any individual and/or entity (or other device or object) that belongs to a group. One or more people assembled by a group coordinator that cooperatively act towards a common purpose as defined by the group coordinator, for example, may be defined as group members.

Further as utilized herein, the terms “target”, “group target”, and/or “recipient” may generally comprise any object, entity, and/or individual that is a subject of group communications in accordance with embodiments described herein. A person who may or may not participate as a group member, for example, but who may be the focal point of a group's purpose or goal, may be considered a group target and/or recipient. For example, the group's purpose may be to organize supportive phone calls to a target in order to make sure that the target has been keeping up with a prescribed medication. In some embodiments, a recipient may comprise a device such as a digital picture frame for which a group is organized to provide and/or supply digital media to.

Some embodiments described herein are associated with a “progress tracking entity”. As utilized herein, the term “progress tracking entity” may generally refer to an entity (and/or object or device associated therewith) that is associated with communications of a group as described herein. In some embodiments, the progress tracking entity may be associated with and/or may facilitate or track a group's progress toward reaching a goal or completing a task. According to some embodiments, a goal or task may comprise a goal or ask of an individual such as a target/recipient for which the group is organized to assist.

As utilized herein, the term “healthcare provider” may refer to a specific type of progress tracking entity and/or an entity otherwise associated with a group in a healthcare capacity. A healthcare provider may, for example, comprise a party interested in receiving updates regarding a group's or target's progress, such as when such progress involves prescription medication compliance. In some embodiments, the healthcare provider may provide an incentive for the Target or group to accomplish one or more goals. A progress tracking entity and/or healthcare provider may, in some embodiments, comprise a “reward entity”.

As utilized herein, the term “reward entity” may generally refer to any entity (and/or object or device associated therewith) that is associated with providing rewards to a group and/or recipient. For example, a healthcare provider may provide free prescriptions to a target whose group reports ninety-five percent (95%) compliance with taking the prescribed medication. Examples of healthcare providers may include but are not limited to: doctors, hospitals, nursing homes, health insurers, nurses, etc.

As utilized herein, the term “third-party company” may refer to a specific type of progress tracking entity and/or an entity otherwise associated with a group and/or the group's progress toward reaching a goal and/or completing a task. A third-party company, for example, may comprise a company and/or other interested party outside of a group (i.e., not a group member) that receives information about a group and/or target's performance associated with a task (such as prescription compliance), as well as feedback information related to that task. Such companies may have access to all or a part of the data collected within the group communications systems described herein, and/or may have the option to perform one or more actions within the system(s) in response to the data, such as anonymously intervene if a problem is discovered and/or send marketing collateral to the support group. Examples of third-party companies may include but are not limited to: pharmaceutical drug makers, pharmaceutical drug retailers, doctors, health insurance companies, the U.S. Food and Drug Administration, etc.

As utilized herein, the term “support call” is used broadly to refer to any form, type, or quantity of communications from a group member in response to a group coordinator's distributed message (e.g., request for help, request for information, task request). Support calls may be made to another group member, the coordinator of the group, and/or the group's target/recipient. In some embodiments, the communication in a support call may be about a topic picked by the group coordinator (e.g., “just broke up with Danny! I need to talk to someone.”), and/or sent regarding a group's common purpose or goal as defined by the group coordinator (e.g., “One person each day needs to call Tony to see if he's taken his medicine with dinner”).

As utilized herein, the terms “support group task”, “group task”, and “task” may generally refer to an event or task that is managed or organized by a Group Coordinator and then performed by a Group Member. Some examples include: Calling a patient to check on prescription compliance; engaging in conversation with the Group Coordinator in a time of need or crisis; participating in a social event; covering a work shift; supporting a person quitting a habit, etc.

As utilized herein, the terms “support group task request”, “group task request”, and “task request” may generally refer to a message sent to a Group Member (e.g., automatically by the system, manually by a Group Coordinator) asking the group member to perform a Support Group Task. In some examples, the message may contain instructions on how to perform the task, how to report information regarding the task, when to perform the task, etc.

As utilized herein, the term “roster” may generally refer to is a set of members of a group, each with stored contact and or profile information, who are available to perform a support group task when prompted by the system controller (or Support Group Application), coordinator, or as scheduled.

As utilized herein, the terms “support group task feedback”, “group task feedback”, and “task feedback” may generally refer to a message sent by a Group Member to provide detail about a specific task. In one example, Task Feedback may be additional information explaining a previously sent message. In another example, Task feedback may be additional message content that does not fall within a message protocol, e.g., in the message “No, Jon was not feeling well today”, “No” is interpreted automatically by the system and indicates noncompliance and “Jon was not feeling well today” is additional feedback regarding why Jon was noncompliant.

As utilized herein, the term “healthcare provider device” may generally refer to any electronic device used by a healthcare provider to receive information provided by a group, group coordinator, group target, and/or system controller. A Healthcare Provider may also use the device to interface with a Support Group Application. Examples include a cell phone, a smart phone, a PDA, a portable game device, a personal computer, a laptop computer, etc. Such a device may include one or more input/output devices, such as but not limited to: an LCD Display, a speaker, a Plasma display, CRT display, a or any other visual or audio output device, a touch screen, a keypad, a trackball, a mouse, a keyboard, a microphone, or any other input device.

As utilized herein, the term “group database” may refer to a database that may store any information related to processes that occur on the system, such as group names, group member contact information, associations of individual members to one or more groups, the designated coordinator, the target, associated healthcare providers, etc.

Some embodiments described herein are associated with a “user device” or a “network device”. As utilized herein, the terms “user device” and “network device” may be used interchangeably and may generally refer to any device that can communicate via a network. Examples of user or network devices include a Personal Computer (PC), a workstation, a server, a printer, a scanner, a facsimile machine, a copier, a Personal Digital Assistant (PDA), a storage device (e.g., a disk drive), a hub, a router, a switch, and a modem, a video game console, or a wireless phone. User and network devices may comprise one or more communication or network components.

As utilized herein, the term “network component” may refer to a user or network device, or a component, piece, portion, or combination of user or network devices. Examples of network components may include a Static Random Access Memory (SRAM) device or module, a network processor, and a network communication path, connection, port, or cable.

Some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

As utilized herein, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

Some embodiments described herein are associated with an “indication”. As utilized herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

### III. Systems and System Processes

A. Group Communication System Overview

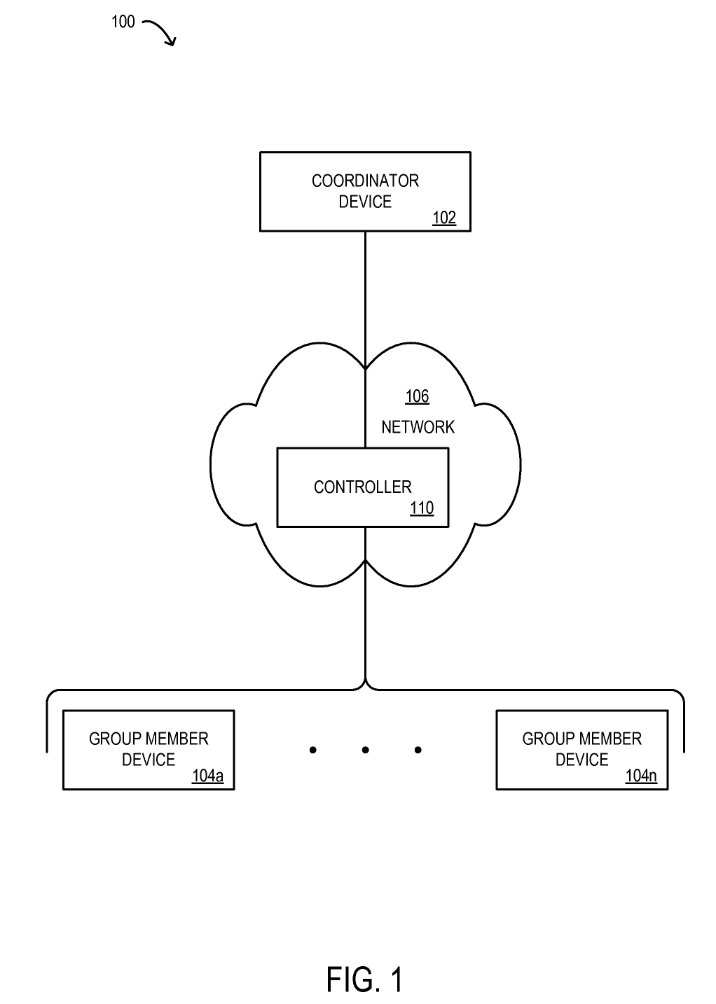

Turning first to FIG. 1, a block diagram of a system 100 according to some embodiments is shown. In some embodiments, the system 100 may comprise a coordinator device 102, a plurality of group member devices 104a-n, a network 106, and/or a controller 110. The controller device 102 may, in some embodiments, be in communication with (and/or be configured and/or coupled for communication with) the controller 110, such as via the network 106. According to some embodiments, the plurality of group member device 104a-n may also or alternatively be in communication with (and/or be configured and/or coupled for communication with) the controller 110 via the network 106. Fewer or more components than depicted in FIG. 1 may be utilized without deviating from the scope of some embodiments. Similarly, while a depiction of a single network 106 is provided in FIG. 1, any quantity and/or types or configurations of networks 106 that are or become practicable may be utilized in the system 100.

In some embodiments, the coordinator device 102 may comprise any type and/or configuration of electronic and/or network device utilized by a group coordinator to interface with a group communications application (not explicitly shown in FIG. 1), communicate with the controller 110, and/or to communicate with members of a group (e.g., via the group member device 104a-n). Examples may include a cell phone, a smart phone, a PDA, a portable game device, a personal computer, a laptop computer, etc. Such a device may include one or more input/output devices, such as but not limited to: an LCD device, a speaker, a Plasma display, CRT display, or any other visual and/or audio output device, a touch screen, a keypad, a trackball, a mouse, a keyboard, a microphone, or any other input device that is or becomes practicable. In some embodiments, the coordinator device 102 may comprise a portable and/or mobile device such as a smart phone.

According to some embodiments, the coordinator device 102 may comprise and/or have access to various programs and/or applications that are configured to facilitate implementation of embodiments described herein. The coordinator device 102 may comprise, for example, a memory (not explicitly shown in FIG. 1) that stores a group communications application. The group communications application may, according to some embodiments, comprise an application that a coordinator may use to perform the following exemplary functions: (i) manage members of a group; (ii) communicate with members of a group; (iii) schedule an event with one or more members of the group (such as a phone call); (iv) establish a goal; (v) track progress towards a goal; and/or (vi) set, send, and/or receive automatic reminders about a scheduled group event.

In some embodiments, the group communications application may exist as software on the coordinator device 102 (and/or a group member device 104a-n), software accessed remotely (e.g., a website) from the coordinator device 102 (and/or a group member device 104a-n), and/or as an application on a platform (e.g., an application on a social networking website). In some examples, privacy controls may be established that selectively provide access to the application by one or more of a coordinator, a member, a healthcare provider, and a target/recipient.

In some embodiments, the member devices 104a-n may comprise any type and/or configuration of electronic and/or network devices utilized by a member of a group. The group member may utilize a first member device 104a, for example, to communicate with the controller 110, communicate with a group coordinator (e.g., via the coordinator device 102), communicate with a target/recipient (not explicitly/separately shown in FIG. 1), and/or to interface with a group communication application. Examples may include a cell phone, a smart phone, a PDA, a portable game device, a personal computer, a laptop computer, etc. Such devices may include one or more input/output devices, such as but not limited to: an LCD Display, a speaker, a Plasma display, CRT display, or any other visual or audio output device, a touch screen, a keypad, a trackball, a mouse, a keyboard, a microphone, or any other input device that is or becomes practicable. In some embodiments, any or all of the group member devices 104a-n may comprise a portable and/or mobile device such as a smart phone.

In some embodiments, the controller 110 may comprise any type and/or configuration of electronic and/or network device via which group communications may be managed, scheduled, relayed, handled, and/or otherwise facilitated or processed. In some embodiments, the controller 110 may be responsible for centrally managing and providing access to a group communications application (e.g., a website, an application on a platform) and/or for at least partially controlling and/or providing information to a locally stored group communications application (e.g., an application running on a smart phone or a personal computer) In one example, the controller 110 may manage incoming messages from multiple member device 104a-n (and/or from multiple groups) and then re-distribute, summarize, redact, edit, forward, and/or otherwise process them based on one or more stored rules. In some embodiments, messages sent to (and thus received by) the controller 110 may be sent to a single address designated to receive such messages, e.g., an e-mail address, an SMS short code, etc.

According to some embodiments, the controller 110 may include a message router (not explicitly shown in FIG. 1). The message router may comprise, for example, software capable of and/or configured to manage and/or route messages within the system 100. The message router may be responsible, for example, for receiving and forwarding messages to one or more devices 102, 104a-n in the system, as well as for aggregating messages, parsing messages, posting a message for public or private view (e.g., on a website), and/or interpreting codes and/or commands embedded in the text of a message (e.g., commands provided in accordance with the Hayes command set).

In some embodiments, the network 106 (e.g., via which the controller 110 communicates with the coordinator device 102 and/or the group member devices 104a-n) may comprise any type and/or configuration of network that is capable of being utilized by an entity associated with the system 100 or a system device 102, 104a-n to communicate with each other and/or with the controller 110. Examples may include: a local area network, a wide area network (e.g., the Internet), a cellular network, a satellite network, a cable network, a Public Switched Telephone Network (PSTN), etc.

B. Group Communication System Processes

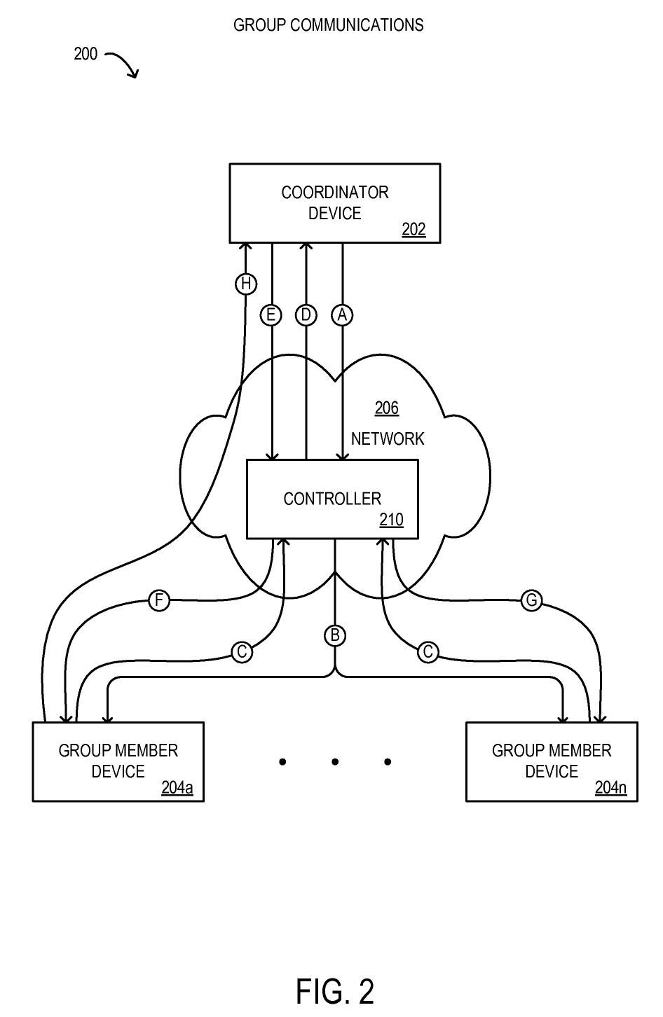

Turning to FIG. 2, a block-flow diagram of a system process 200 according to some embodiments is shown. In some embodiments, the system process 200 may performed and/or implemented by and/or otherwise associated with one or more specialized computers, computer terminals, computer servers, computer systems and/or networks, and/or any combinations thereof (e.g., such as by the system 100 of FIG. 1). The block-flow diagrams and flow diagrams described herein do not necessarily imply a fixed order to any depicted actions, steps, and/or procedures, and embodiments may generally be performed in any order that is practicable unless otherwise and specifically noted. Any of the processes and methods described herein may be performed and/or facilitated by hardware, software (including microcode), firmware, or any combination thereof. For example, a storage medium (e.g., a hard disk, Universal Serial Bus (USB) mass storage device, and/or Digital Video Disk (DVD)) may store thereon instructions that when executed by a machine (such as an electronic processor) result in performance according to any one or more of the embodiments described herein.

In some embodiments, the system process 200 may be implemented via various components such as depicted in FIG. 2. The system process 200 may be implemented by, for example, a coordinator device 202, one or more group member devices 204a-n, a network 206, and/or a controller 210. According to some embodiments, any or all of the components 202, 204a-n, 206, 210 of the system process 200 may be similar in configuration and/or functionality to the similarly named and/or numbered components described with respect to the system 100 of FIG. 1 herein. Fewer or more components and/or various configurations of the components 202, 204a-n, 206, 210 may be included in and/or utilized to implement the system process 200 without deviating from the scope of embodiments described herein.

### 1. Example #B1

The processes described in the following example are contemplated as systems for managing tasks and a variety of messages related to the managed task. The systems can be used to manage tasks and messaging related to all types of group purposes, as described herein. Many examples provided below are described in the context of one specific use of the group communication system. However, it should be understood that the group communication system is not only contemplated for the specific uses presented in the examples and may be utilized by a group to manage a wide range of individual, everyday tasks or problems such as picking up groceries or finding someone to talk on the phone with. It may also or alternatively be utilized to manage recurring, everyday tasks like monitoring prescription compliance, completing homework, picking up children from school, monitoring a diet, supporting a target who has quit smoking, etc.

According to some embodiments, an individual and/or entity that defines a group and/or that is a member of a group who is designated as the coordinator of the group, may utilize and/or operate the coordinator device 202. The coordinator device 202 may be utilized for example, to access a group communications application (not explicitly shown in FIG. 2). In some embodiments, the group communications application may provide the coordinator with the ability to create a group by inputting contact information into the coordinator device 202 and then requesting (e.g., as may be represented by process “A” of FIG. 2) that the controller 210 send out invitations to the group members (e.g., via the network 206 and via the group member devices 204a-n), e.g., as may be represented by process “B” of FIG. 2. In some embodiments, the invitations may go to the controller 210 (e.g., via “A”) before being distributed to the group member devices 204a-n (e.g., via “B”). Group members utilizing group member devices 204a-n may, according to some embodiments, accept or decline the invitations such as by sending a message back through the network 206 and to the controller 210 (e.g., as may be represented by process “C” of FIG. 2).

In some embodiments, a group coordinator may plan an event, such as a support call request. Support call requests may be sent, for example, from coordinator device 202 (e.g., via “A”) and routed through network 206 and/or through the controller 210 (e.g., via “B”). In one example, the controller 210 (and/or a message router thereof) may determine where to send the message by looking up contact information stored in a database (not explicitly shown in FIG. 2). the controller 210 may then, for example, forward the message through network 206 to one or more of the group member devices 204a-n. Determination of where to send the message may also or alternatively be based on rules established by the coordinator (such as may be stored and/or accessible to the group communications application).

According to some embodiments, group members may utilize group member devices 204a-n to send a response to a coordinator's request by responding back directly to the coordinator device 202 (e.g., via “H”) or to the controller 210 (e.g., via “C”). In embodiments where responses are sent to controller 210, the controller 210 (and/or the message router component thereof) may combine individual messages into one single summary message. In one example, a response may have one or more code words that are interpreted by controller 210. For example, the response may consist of “Y” for a positive response and “N” for a negative response—which may facilitate the creation of summary information output to the coordinator device 202 (e.g., via “D”). In another example, messages may be sent to a support group application of the controller 210, which may determine the coordinator of the group (e.g., by querying a database) and display the message on coordinator device 202.

In some embodiments, a coordinator may send out a follow up message (e.g., via “E”), such as by selecting an automatic message (e.g., a template) from the group communications application, and/or by manually defining messages. In one example of sending an automatic follow-up message, the coordinator may select one or more members that responded to participate in an event. This selection may be done, for example, through the group communications application. The controller 210 may then, for example, utilize the message router thereof to send out one or more follow up messages (e.g., via “F” and/or “G”) to the group member devices 204a-n (e.g., based on the coordinator's selection). For example, the first group member device 204a may receive a message (e.g., via “F”) stating, “You have been chosen to make a support call”, and a second group member device 204n may receive a message stating, “You do not have to make a support call today.”

In one example, the controller 210 (and/or group communications application) may track communications flowing through the system process 200 and may alert one or more entities when communication is incomplete. For instance, if a coordinator sends out a request to one or more members, and no response is received, the controller 210 can cause the group communications application to output a message to the coordinator device 202 stating, for example, “Member [Name] has not responded to your message. Would you like to re-send the request?”.

In another example, the controller 210 (and/or group communications application) may track and/or aggregate information about a goal or purpose. For example, the coordinator device 202 and/or the group member devices 204a-n may send progress information to the controller 210. The controller 210 may then, for example, store progress information (e.g., in a database). Progress information can then, according to some embodiments, be displayed by accessing the group communications application.

In some embodiments, the group communications application may be stored and/or run locally on the coordinator device 202 (and/or on one or more of the group member devices 204a-n). In such embodiments, some or all of the processes and/or responsibilities of the group communications application may be performed directly on and/or by the coordinator device 202 (and/or on and/or by one or more of the group member devices 204a-n).

### 2. Example #B2

According to some embodiments, a group may be defined, such as by assembling a broadcast list. A coordinator may, for example, select a group of individuals to receive a broadcast message such as by uploading a phone contact list to an account of the coordinator (which may include a list of names, phone numbers, etc.). In some embodiments, the coordinator may attach or assign tags to each contact name to facilitate using filters to create a distribution list quickly (e.g. “Nikita:Wedding:Family”). Groups may, in some embodiments, be defined by selection of pre-set distribution lists (e.g., online). Various functions such as assigning names to a group, naming a group, editing a group, and/or uploading pre-set distribution lists from phone contact lists, may be available via the group communications application.

In some embodiments, lists of group members may be defined and/or assembled via the coordinator device 202. The coordinator may utilize the coordinator device 202, for example, to manually select group member names from a phone list, organized members alphabetically, organized members by most frequent communications, etc. Filters may be utilized such as by typing in tag or group list name, and the group communications application may automatically filter contact lists (e.g., the group list) to names associated with the specified label/tag/name. The coordinator may then, for example, select/deselect group members from the filtered list.

In some embodiments, audio selection of names may be provided. Names, nicknames, or tags may be spoken, for example, to select group members. The controller 210 may check names against all names that have been associated with a group previously. Confirmation tones may be provided by the controller 210 when a group member's name is recognized and/or audio cues may be provided when a name does not match (e.g. “Did you say Nick or Nicole?”). In some embodiments, the coordinator may review names on a final list before sending a broadcast message (and/or otherwise defining a message) to the controller 210. Group member names may be edited, contact list names may be appended to a message sent to the controller 210, and/or group members may be identifiable by the system process 200, for example, by name and/or phone number (or other contact or indentifying information).

In some embodiments, once a group is defined (and/or as the group is being defined), a broadcast/distribution message may be composed, selected, generated, and/or otherwise defined. The coordinator may create a message to send to the controller 210, for example. The format of the message may delineate, in some embodiments, what various parts of the message represent. Components of a message may include, for example, an SMS short-code, SMS text, MMS content, a requested time to schedule a talk or chat, a requested amount of time for talk or chat, and/or a level of urgency indicator. It should be understood that either or both of group definition and/or selection and message definition and/or selection may be accomplished via the coordinator device 202 and/or via the controller 210. In some embodiments, either or both of these functionalities may occur via and/or include communications via “A” in FIG. 2.

According to some embodiments, once a message to be sent to the group is defined, it may be distributed to the group, via “B” in FIG. 2. In some embodiments, the controller 210 may parse the message, reformat, and/or append additional information the group members may desire and/or need in order to respond. In some embodiments, the message broadcast and/or distributed tot the group may comprise a name of a target/recipient, an identification of a task, a requested time to schedule a talk or chat, a requested amount of time for talk or chat, a level of urgency indicator, and/or instructions for reply (short code or other).

In some embodiments, the controller 210 may receive and/or accept responses from the group member devices 204a-n, via “C” of FIG. 2. Group members who opt to respond, for example, may send a message back to the controller 210 (e.g., via “C”). The message format may delineate various portions such as a status (e.g., “Yes/No”) and/or a condition (freeform text message). According to some embodiments, the controller 210 ties received responses back to the original message (e.g., the broadcast message), such as by storing an indicator, tag, reference, or key in a database.

In some embodiments, the controller 210 may generate a group results message. The controller 210 may, for example, merge all the responses from group members into a single report that is sent to the coordinator device 202, via “D”, at regular intervals. The timing of the initial report, intervals between subsequent updates, and duration of time during which updates will be sent can all be configured by the coordinator on the web or on their phone (e.g., the coordinator device 202).

In some embodiments, an initial status report message (sent after a first predetermined time period after the original message is sent to the group members) may comprise a name of a group member, a status of the group member (e.g., “Yes/No”), a conditional “Yes” (indicator for comment added), a conditional “No” (indicator for comment added), an “NA” or “No Answer” indication, one or more group member attachments (e.g., a text message), MMS, voicemail, and/or a time the message was sent/received. In some embodiments, the controller 210 may combine messages that exceed a predefined length into one message for easier reading. According to some embodiments, one or more status update messages may be provided (e.g., via “D”), such as after a second predetermined time period after the original message is sent to the group members and/or at some predetermined interval after the initial status report message is sent. The status update message(s) may generally include elements similar to those of the initial status report message, as desired. Any or all of the status report messages may be sent/received via any desirable communication medium such as SMS, MMS, and/or e-mail.

In some embodiments, while the group communication session is open (e.g., after an initial message is sent to the group via “B” and before the coordinator indicates closure of an associated task), the coordinator may communicate directly with group members outside network 206 and/or without utilizing the controller 210. The coordinator will be able to send “reply all” communications to an entire list or subset of group members. One type of “reply all communication” comprises a “closing message”.

For example, when the coordinator would like to stop receiving updated reports (e.g., via “D”), the coordinator may send, via “E”, a closing message to the controller 210. In some embodiments, the closing message may comprise an SMS short-code (e.g., a command indicating it's a close request (e.g. “CLZGTXT”)), a name of a group member selected/accepted by the coordinator, “release message” content (e.g., text-based message that any released/non-selected group member who has responded will receive—the coordinator may select from a set of standardized release messages, the coordinator may customize a release message, the coordinator may opt to send one response to all “Y” and/or a different message to all “N” responders, the coordinator may personalize individual release messages), and/or a message override (e.g., the coordinator may indicate “Don't send any Release messages” and/or the coordinator may indicate to send release messages even to people who did not respond).

In some embodiments, a closing and/or release message may then be sent by the controller 210 to the group member devices 204a-n, via “F” and/or “G” of FIG. 2. An automated closing message may, for example, be sent from the controller 210 to the first group member device 204a, via “F”, informing them that they have been selected (e.g., by the coordinator and/or by the controller 210) and/or an automated release message may be sent to the second group member device 204n, via “G”, informing them that the request has been closed. If a “late” group member has included a personal message in their response, the coordinator may opt (e.g., via web configuration) to have late responses forwarded to the coordinator. In some embodiments, such as in the case that the coordinator selects a group member to complete an enumerated task (e.g., that may have been presented in the original broadcast to the group members), communications with the selected group member may be imitated, e.g., via “H”). The selected group member may be prompted to contact the coordinator, for example, or the controller 210 may automatically initiate and/or establish a communication link (“H”) between the coordinator device 202 and the first group member device 204a.

It should be understood that the above example discusses text messaging (e.g., SMS) as a primary mode of communication between members, which is only one example of how members may communicate with each other and the controller 210. The system process 200 can be designed to accommodate other forms of communication, besides or in addition to text messages, including but not limited to: e-mail, instant messages, multimedia messages, voice messages, video messages, blog posts, messages posted to a website such as a profile on a social networking website, etc.

In some embodiments, a member may be added a group request for further updates (e.g., after an initial request has been sent), group lists may be easily changed via an interface (e.g., a mobile phone interface) of the coordinator device 202, the coordinator may select one or more desired group members from a checklist (e.g., in the summary status report generated by the controller 210), conference calls and/or chats may be facilitated, coordinator accounts may be created, group lists may be managed, group list assembly may be configured, group members may be sorted and/or ranked, status report options and/or configurations may be defined, message history/tracking may be viewed, and various parameters such as a default length of time a request should remain open or a default length of time elapsed between updates, may be established.

C. Scheduled Group Communication System Overview

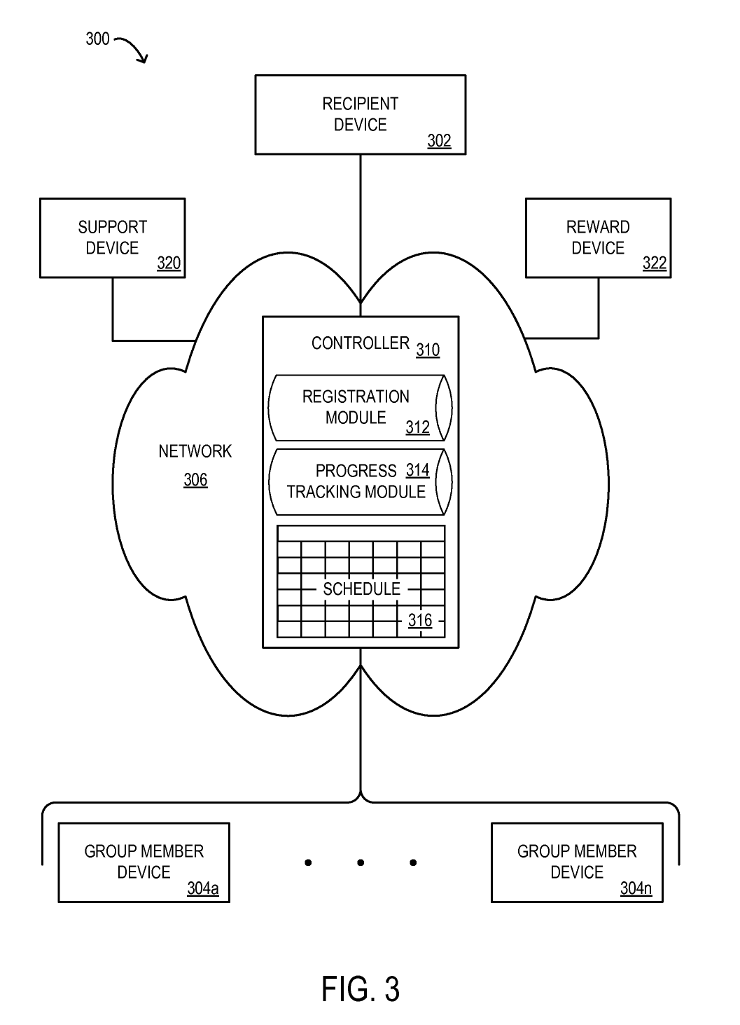

Turning now to FIG. 3, a block diagram of a system 300 according to some embodiments is shown. In some embodiments, the system 300 may comprise a recipient device 302, one or more group member devices 304a-n, a network 306, and/or a controller 310. The controller 310, according to some embodiments, may comprise a registration module 312, a progress tracking module 314, and/or a schedule 316. The system 300 may also or alternatively comprise a support device 320 and/or a reward device 322. According to some embodiments, any or all of the components 302, 304a-n, 306, 310 of the system 300 may be similar in configuration and/or functionality to the similarly named and/or numbered components described with respect to the system 100 of FIG. 1 herein and/or the system process 200 of FIG. 2 herein. Fewer or more components and/or various configurations of the components 302, 304a-n, 306, 310 may be included in and/or utilized to implement the system 300 without deviating from the scope of embodiments described herein.

In some embodiments, the controller 310 may comprise a web and/or Interactive Voice Response (IVR) server and the registration module 312 may comprise an interface (e.g., a web interface and/or IVR interface) configured to allow group coordinators, group members, and/or recipients to register with the system 300. A recipient who is a patient taking a prescription medication, for example, may utilize the recipient device 302 to interface with the registration module 312 and become active with the system 300. The controller 310 may, for example, receive registration information and/or invitation information (e.g., in the case that the registering party is not the recipient) via the registration module 312. Via the registration module 312, a user may access a group communications application, establish themselves or another member as the group coordinator, name the group, provide group information (e.g., profile information), and/or establish/define a purpose for the group (e.g., “to periodically call grandma and reminder her to take her pills”, “to check in on Lois to see if she's keeping up with her medicine).

The user/coordinator may establish and/or define or indentify (e.g., provide contact and/or identifying information) a group target/recipient (which may be the user/coordinator), e.g., a person that the group is supporting, and/or register a healthcare provider with the group (e.g., in the case that the group is healthcare-related). In some embodiments, the registration may activate one or more rewards programs associated with the system 300 (e.g., if the group reports that the target/recipient takes his or her medication over X amount of consecutive days, then: a discount is offered on the medication, the group is entered into a raffle, a donation is made to a charity, the group wins money, and/or the target wins money).

In some embodiments, the user/coordinator may provide coordinator information (e.g., contact and/or indentifying information and/or a relationship to the target), select and/or invite one or more people to become part of a group that works together to toward a persistent purpose or goal (e.g., input invitee information, group member name, personal information (e.g., relationship to grandma), input invitee contact info (e.g., phone number, e-mail address, a communication service account, an instant message handle, and/or an account on a social networking website), upload pre-set distribution lists from his or her phone contact list, manually select group member names from a contact list, organize the list alphabetically, review and/or confirm invitee information before sending out invitations to the group, edit candidate information, compose a message to include in the invitation, select a pre-composed message to include with the invitation, and/or upload media to be included in the invitation.

According to some embodiments, the registration module 312 and/or the controller 310 may be utilized to transmit invitations to invitees. The controller 310 may receive invitation information from the user/coordinator, for example (such as via a group communications application), and may send an invitation to each invitee. The controller 310 may, for example, determine contact information for each invitee, assemble an invitation message, and transmit the message via the network 206 to one or more of the group member devices 304a-n. Messages may be sent in a variety of formats, such as but not limited to: an e-mail, a text message in an SMS, a multimedia message in an MMS, a phone call, an instant message, and/or a post to a website.

Messages may contain information about how to respond: e.g., “Respond “Y” to this message to accept the invitation”, “click on the link below to register with the support group”, “Call the following number to accept this invitation”. In some embodiments, invitations can be sent directly to a group member device 304a-n without being sent to the controller 310.

According to some embodiments, the controller 310 may receive invitation responses from invitees and establish/confirm group members. Invitation responses may be sent directly to the coordinator and/or may be sent to the controller 310. Invitees may respond with an indication of whether or not they want to join, e.g., a response of “Y” may automatically be interpreted by the controller 310 as consent to join the group; a response of “N” may be automatically interpreted by the controller 310 as a declined invitation; e.g., invitee clicks one link to join and another link to decline; e.g., invitee visits a website and indicates whether or not the want to join.

In some embodiments, the controller 310 may send an automatic reminder message if invitees do not respond to invitation within a predetermined period of time. The controller 310 may also or alternatively alert the coordinator if an invitee does not respond to an invitation in the predetermined amount of time. The controller 310 may record each response and form the group member list based on the responses received, e.g., the system 300 interprets responses automatically and updates a group member list.

The user/coordinator may then review responses and “activate” each member. The user/coordinator may also be given a list of responses from members and select whether or not to add them to a group member list. An invitation response may include schedule information (i.e., times when a group member is available), e.g., “I can help Monday through Friday any time between 1 and 5 PM; e.g., invitees select times on a calendar when they are free. The controller 310 and/or the user/coordinator can update the schedule 316 or otherwise associate each member with their input schedule info.

In some embodiments, the support device 320 may comprise a device associated with an entity that provides support (e.g., professional support to the group and/or to the recipient). In the healthcare context, for example, the support device 320 may comprise a device operated by a physician, nurse, health insurer, etc. The reward device 322 may comprise a device associated with a reward entity and/or a progress tracking entity, as described herein. The reward device 322 may, for example, comprise a device associated with a merchant, health insurer, manufacturer, or another entity that may, for example, provide benefits based on the progress of the group and/or recipient with respect to a particular goal and/or task.

D. Scheduled Group Communications System Processes

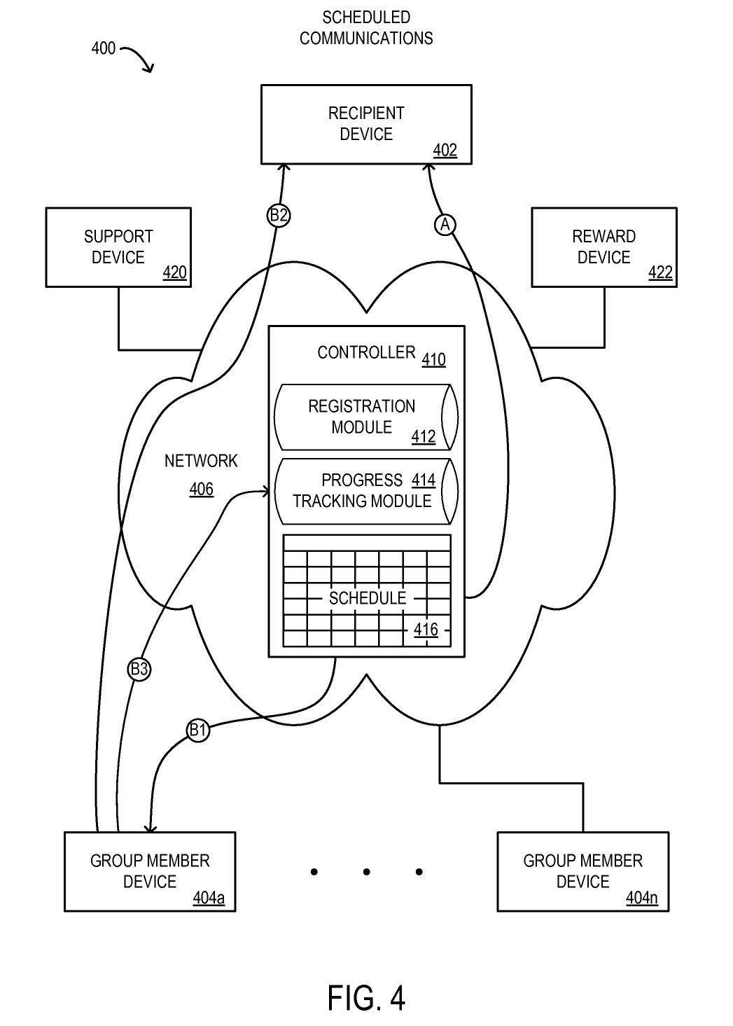

Turning to FIG. 4, a block-flow diagram of a system process 400 according to some embodiments is shown. In some embodiments, the system process 400 may performed and/or implemented by and/or otherwise associated with one or more specialized computers, computer terminals, computer servers, computer systems and/or networks, and/or any combinations thereof (e.g., such as by the systems 100, 300 of FIG. 1 and/or FIG. 3 herein). In some embodiments, the system process 400 may be implemented via various components such as depicted in FIG. 4. The system process 400 may be implemented by, for example, a recipient device 402, one or more group member devices 404a-n, a network 406, and/or a controller 410. In some embodiments, the controller 410 may comprise a registration module 412, a progress tracking module 414, and/or a schedule 416. One or more of a support device 420 and/or a reward device 422 may also or alternatively be provided. According to some embodiments, any or all of the components 402, 404a-n, 406, 410, 412, 414, 416, 420, 422 of the system process 400 may be similar in configuration and/or functionality to the similarly named and/or numbered components described with respect to the systems 100, 300 of FIG. 1 and/or FIG. 3 herein. Fewer or more components and/or various configurations of the components 402, 404a-n, 406, 410, 412, 414, 416, 420, 422 may be included in and/or utilized to implement the system process 400 without deviating from the scope of embodiments described herein.

### 1. Example #D1

In some embodiments, the system process 400 may comprise facilitating the creation of a support call request. One or more group members to whom to send a request may be selected and/or determined, for example, and/or the format of the request (e.g., SMS, MMS, Phone Call, e-mail, etc.) may be defined. A request message may be created and/or generated, such as by the controller 410 automatically generating a message, a coordinator selecting from a set of stored templates, a coordinator inputting an original message, and/or a coordinator modifying a stored message, e.g., “Can you call Lois today? Ask if she took the red pill in the morning and the clear liquid at lunch. Be great if you can let me know by 10:30”, “Can you call Nikita by 1:30 today? Be great if you let me know by 9 AM. Thx”.

In some embodiments, a coordinator may receive reminders when he or she has not sent out a support call request. The group coordinator can establish a threshold time by which a request should be sent. Reminders may be automatically sent by the controller 410 when a group member has not accepted (e.g., sent a response) to a support call request. The coordinator can review, confirm, and submit a request.

According to some embodiments, the controller 410 may transmit a support call request (or other message) to the group member devices 404a-n, via “B1” of FIG. 4. The support call request may be prompted and/or initiated by a coordinator, or may be triggered by the schedule 416. In the case that no group member is scheduled to be available and/or in the case of a non-schedule triggered request, the controller 410 may directly contact the recipient by sending a message to the recipient device 402, via “A” of FIG. 4. The support call request may be transmitted via a text message, e-mail, or other communication media, and/or may be submitted as input to a group communications application. The support call request may also or alternatively be transmitted via a phone call to an IVRU (not explicitly shown in FIG. 4).

In some embodiments, the controller 410 may configure a request and send to the selected group members, e.g., the controller 410 may look up group member information in a group database; e.g., the controller 410 may combine information from previous processes to create a support call request; e.g., the controller 410 may include information from a database containing task information when automatically composing a response, such as task description, task time period, etc.

The controller 410 may send the request to a device selected by the coordinator and/or to a default device. In some embodiments, the request may be sent directly from a coordinator to a group member device 404a-n.

In some embodiments, a support call response may be received, e.g., via “B3” in FIG. 4. Group Members that have received a support call request respond with an indication of availability, e.g., “Yes I can do that”, “Sorry I'm busy today”, a response of “Y” may automatically be interpreted by the controller 410 as consent, a response of “N” may be automatically interpreted by the controller 410 as a declined request, e.g., Group Member clicks a link to accept or another link to decline, Group Member visits a website and indicates whether or not they able to participate, etc. Group Member may add additional information to a response, e.g., “I can only help after 10 AM, is that OK?” The controller 410 may send an automatic reminder message to the Group Members if the Group members do not respond to a request in x period of time.

According to some embodiments, a support call response and/or a summary message generated thereof may be transmitted to the coordinator. The controller 410 may create an aggregate message before sending to the coordinator. System process 400 may wait a predetermined amount of time. During that time the controller 410 may combine incoming messages into one message. The controller 410 may create a summary message; e.g., “Jane said yes, Paul said no, Tina said No”. The controller 410 may update responses to the Support Group Application as responses are received. May be viewed by the coordinator as the controller 410 updates the application with response information. Support Group Application may periodically “synch” with the controller 410 in order to update the latest response information. The controller 410 may alert the coordinator if a group member does not respond to a request in x amount of time. The controller 410 may record each response and update an “availability checklist” based on the responses received; e.g., a list of one or more group member names with a mark next to all members who responded positively to the request. Prompt: “Send a new request”. If all of the one or more requests are declined, then the coordinator may be prompted to send a new request.

In some embodiments, the controller 410 may facilitate creation of a follow up message. The controller 410 may select a Member to send a follow up message to. If multiple Group Members received the request: Coordinator may review which members are available according to response information. The coordinator may select one or more of the group members that he or she will designate to carry out the Support Call. If only one request was sent out to one member and/or only one member responded positively to the request. Coordinator may confirm that this member will be performing the support call. System may automatically interpret response and confirm that the member will be performing the support call. Coordinator then inputs or selects a template message. May be a notification of who has responsibility for support call. E.g., “Thank you all for responding. Chris will take care of it”. May be a reminder for the person to perform the support call. E.g., “Remember to Call Grandma”. Coordinator may review, confirm and submit message. The controller 410 may automatically send message. E.g., at a predetermined or scheduled time. Automatically after member is selected. E.g., one or more types of messages may be sent out automatically based on selection. E.g., to selected member “Thanks a bunch, I'll send a reminder to you later”. E.g., to those not selected, “Thank you for responding but Jon will do it.

In some embodiments, a follow up message may be transmitted, e.g., via “B1”. The controller 410 may receive follow up information from coordinator. May be transmitted via a text message. May be transmitted via email. May be submitted as input to Support Group Application. May be transmitted a phone call to Interactive Voice Response Unit. The controller 410 may configure a follow up message and send to the selected group members; e.g., the controller 410 may look up group member information in a group database; e.g., the controller 410 combines information from previous step to create a support call request. The controller 410 may send the follow up message to a device selected by the coordinator. The controller 410 may send the follow up message to a default device. Stored when the group member accepted the invite. Input by the Group member. Input by the Coordinator. A follow up message may be sent directly from a coordinator to a group member device 404a-n.

According to some embodiments, a progress update may be received from the group member, e.g., via “B3”. The Group Member can indicate progress towards a goal after he or she has completed a support call; e.g., “Grandma took her medication”. May be sent using any of the messaging methods discussed above. May be simple message that can be decoded by the controller 410; e.g., “Y” if the Target accomplished the daily goal (e.g., took their medication). The controller 410 may alert the coordinator if a group member does not send a progress report message. The controller 410 may send an automatic reminder message to the Group Member if the Group member does not send a progress update message in before the expiration of x amount of time or before a predefined time.

In some embodiments, progress may be updated via the progress tracking module 414. The controller 410 may record each progress update in the progress tracking module 414. The controller 410 or coordinator may update a “progress tracker” based on the responses received; e.g. may be a calendar that marks the days that the goal has been reached; e.g., may be a list of days that the target accomplished the goal and/or did not accomplish the goal. Support Group Application may display the progress tracker, which is available to one or more of the coordinator, the group members, a healthcare provider, the target. The controller 410 may cause automatic progress updates to be sent to one or more of the coordinator, the group members, a healthcare provider, the target. The Healthcare Provider may record or update the group on a reward status: Progress towards the reward. If the reward is due then the group or target may be notified.

### 2. Example #D2

The process steps in Example #D2 (as well as others herein) are intended to describe a Support Group System wherein multiple Group Members are managed by a Group Coordinator in regards to performing one or more Support Group Tasks. The tasks described below may be tied to a time period during which a Group Member is asked and/or expected to perform a task. The Group Member may then send one or more messages to the Support Group System and/or Group Coordinator providing information about one or more aspects of the Support group Task (e.g., the group member's availability, task completion or incompletion, task status or results, feedback information providing further details about the task, etc.). The timing and content of the message may affect, for example, the way a message is processed by the system and/or subsequent actions performed by the system.

In one example, a Support Group may be assembled by a Group Coordinator to monitor the Group Target's compliance to a prescribed medication regimen. To do so, the Group Coordinator uses the Support Group Application to establish a recurring Support Group Task (e.g., stored via the schedule 416) to be completed every day. The task involves one member calling the Target between, for example, 12 and 5 each day (e.g., via “B2”) to determine if he has taken his medication, and then reporting back whether or not the target was compliant. The Group Coordinator also establishes a roster of Group Members who have volunteered to accomplish this task.

Each day, the Group Coordinator sends out a request to one or more Group Members who send a message to the system to indicate whether or not they are available to perform a task—the timing of the Member's message lets the system know which day's task they are performing. Additionally, group members are required to send a message to the system, between a specified time period (12 and 5) indicating whether or not the target has been compliant with that day's prescription. The system automatically determines the content of the message (yes/no) and using that information plus information about the sender and the timing of the message, the system can determine how to report the results of that day's task. The process is repeated the next day with a new Group Member and a new set of messages. Each day's interpreted results are recorded by the system and stored in a task history associated with the Support Group.

Additionally, the results interpreted by the system may trigger conditional actions by the system, such as messages sent to other group members, the group coordinator, etc. For example, if the target is non-compliant in 3 consecutive time periods, a message may be output to members of the group, such as the Group Coordinator. One way to use a Support Group System for this purpose is discussed in more detail below in the following process steps: register a roster of users comprising at least two cell phone numbers; receiving a first text message from at least one of the registered cell phone numbers from the roster during a first period of time; receiving a second text message from at least one of the registered cell phone during a second period of time; processing and interpreting received messages; determine output, based on interpretation of message; and/or update support group database.

Some embodiments may comprise registering a roster of users comprising at least two cell phone numbers. A roster is a listing of a set of members of a group, each with stored contact and or profile information, who are available to perform a support group task when prompted by the system controller (or Support Group Application), coordinator, or as scheduled. In one example, seven group members may exist on a roster, and each member performs a daily task one time each week as requested by the group's coordinator.

The controller 410 or Support Group Application stores information about each group member on the roster. Group Coordinator's or Group Members' profile information may include:

additional Contact information; cell phone number; telephone number; e-mail address, a communication account handle (e.g., Instant Messenger Name, VoIP name, etc.), a home address, a member name, a full legal name, a user name, other personal/profile information, such as relationship to group target, availability, dates and times when the group member is willing to perform a support group task, and/or a schedule 416 of when the group member intends to perform a support group task.

In one example, a group registration interface in a Support Group Application may be used by the Group Coordinator to create a list of group members, which may comprise at least each member's cell phone number. Group Coordinator or Group Members may access the Support Group Application, and therefore the group registration interface, via a Coordinator or a group member device 404a-n.

Support Group Application may be stored locally, or Support Group Application may be stored at a central location (controller 410) and remotely accessed by system entities over network 406. Information may be input using any of a number of input devices, including but not limited to: a keypad; a microphone; a keyboard; a touch screen; an interactive voice response unit (IVRU); etc. Group member registration may comprise invitation and invitation acceptance, as described above.

Roster registration information may be stored locally on a Group Member/Coordinator Device, or on a central server such as the controller 410. For example, a database (e.g., Group Database) may be used to store roster data and be accessed when roster information is needed as required by this or other steps in the process.

Receiving a first text message from at least one of the registered cell phone numbers from the roster during a first period of time may occur in some embodiments. In one example, the message is sent from a group member device in response to a support group task request. This purpose of this message may be, but not limited to, one of the following examples: to indicate that the group member is available to perform a Support Group Task; to report the completion of a Support Group Task; to report the results or details of a completed Support Group Task; to provide feedback or further details about a Support Group Task.

In one example the controller 410 receives a message from a group member. Upon receiving a message, the controller 410 may determine the origin of the message. Identifiers may include: phone number; text message short codes; e-mail address.

The controller 410 may use the origin identifier to determine whether the sender is on roster stored by the System. If it determines yes, it may also determine which Support Group they are a member of, and then forward the message to the corresponding Group Coordinator's device.

In one example, the message may be sent as a general message (e.g., SMS, email) from the central controller 410. The Support Group Application running on the Group Coordinator device may automatically recognize the message as a part of the Support Group process based on origin of the message.

In another example, the message may be sent directly to the Support Group Application on the Group Coordinator Device. In another example a Group Coordinator Device (e.g., running a Support Group Application) receives the message from the Group Member. In such an example, the Support Group Application running on the Group Coordinator Device is monitoring incoming messages. When a message is received from an group member on the roster, the Application may determine whether to use the message for support group purposes.

The application may know if the message is from a group member on the roster by comparing the origin of the message to those stored in the roster (e.g., email address, phone number, short code, etc.). The determination may be based on: whether that group member is on the roster, whether there is support group task to be completed, whether that group member is assigned to a particular support group task, whether that message contains a code recognized by the application (e.g., “Task Complete” or “Complete” or “Yes” or 1, etc.).

A Group Member may send a message to the controller 410 in response to a Support Group Task that is assigned to a specific time period. The time period refers to a pre-set, specific time and date by which a specific group member is supposed to complete a support group task.

A Support Group task may require one or more messages to be sent to the Support Group System within a specified time period comprise a completed support group task.

A Group Coordinator may create a Support Group Task and assign that Task a specific time period using a user interface that may be stored on a Coordinator Device, Support Group Application and sent to the Central Controller and/or Member Devices via the Communication Network.

A Task (and therefore its time period) may be persistent within the system (e.g., a task may be performed every day between 12 and 5)

A specific Group Member may be manually assigned to one or more Support Group Tasks by a Group Coordinator or Group member. To do so, each may use a Coordinator Device, Member Device, or Support Group Application user interface.

The Central Controller may receive a message from a Group Member in response to a prompt sent by the System Controller or Group Coordinator via the Support Group Application or via the Coordinator Device. Automatically and Manually sent prompts are described in more detail in Example 2, above.

The Central Controller may forward a message received from a Group Member to the Coordinator Device or Support Group Application.

The time period during which the message is received may affect how the message is processed and interpreted by the system.

As discussed above, the group member message may be received in response to a Support Group Task Request. These tasks may occur x times per y time period. The time period during which a response is received may tell the system one or more of:

What Task Request is this message related to?

Which Task, of multiple, is this message in response to?

One example of a time period may be a “prescription compliance period”, which refers to a period of time within which the system controller will track at least one member from the roster to perform a support group task to completion.

For instance, a “prescription compliance period” may be 24 hours, because the purpose of the group is to make sure that the group's target has taken her medication, which she has been prescribed to take once daily. During which period the system controller may send a request to a

Group Member to place a call, confirm the member's availability, receive confirmation that the duty of calling has been performed, and store feedback entered by the leader gathered during the call.

In one example, the Group Coordinator may use a set up interface in a Support Group Application to set the “prescription compliance period” using a Coordinator Device or a Member Device.

Time period information may be input using any of a number of input devices, including but not limited to: a keypad; a microphone; a keyboard; and/or a touch screen.

The Central Controller or the Support Group Application stores the “prescription compliance period” and may include additional information related to it, including:

When a period starts (e.g. time of day, specific weekday)

When a period ends (e.g. time of day, amount of time from period start, or calendar date)

How frequently the period occurs (e.g. daily, weekly, etc.)

Receiving a second text message from at least one of the registered cell phone during a second period of time,

Messages may be sent from a Member Device to the System Controller after the first time period concludes. The System Controller may determine whether the message is associated with the first period or a subsequent period, based on a number of criteria, including, but not limited to: Whether or not the origin of the message is from the group member who is assigned to the current support group task; Whether or not the message is received in a current or previous time period or prior to or after a scheduled event; Whether or not a new second task is scheduled to occur during a second time period, in which the second message was sent; Whether the contents of the message received pertain to a current or previous support group task.

In one example, time periods for more than one support group task may overlap. The System Controller may categorize messages received as being related either to a specific time period or task, based on the criteria described in the step above.

Processing and interpreting received messages: The Support Group System is contemplated to be used by a support group to manage a wide range of everyday tasks or problems such as picking up groceries or finding someone to talk on the phone with. It may also be used to manage recurring, everyday tasks like monitoring prescription compliance, such as completing homework, picking up children from school, monitoring a diet, supporting a target who has quit smoking, etc. As such, each task may have a unique set of associated message types:

E.g., one type of message from the Group Member may indicate whether or not the member is available to perform a support group task; E.g., “Yes”; E.g., “No, I am busy today”; E.g., one type of message from the Group Member may indicate whether or not a task has been completed; E.g., “Complete”; E.g., “I've Called Grandma”; E.g., one type of message from the Group Member may indicate a status or result of a task; E.g., “Yes, I've picked up the groceries”;

E.g., “Yes, Grandma has taken her medication”; E.g., “No, the dog did not go out today”;

E.g., “No, Grandpa did not take his medication”; E.g., one type of message from the Group Member may indicate supplemental task details; E.g., “Grandma said she was nauseous”; E.g., “Ben only took the green pill, he forgot to take the blue one”; E.g., “I picked up Sally from school, but Timmy has detention and has to be picked up at 4:45”

The system may be designed to automatically interpret a message, based on a categorization of the message type. The system may be designed to store a set of rules that: Define the types of messages for each task type, Define how the system will identify message types, as described in some examples below, Define how the system will interpret message content.

In one example the rules are stored on the System Controller and transmitted to the Group Support Application and Coordinator Device. Additionally, the rules may be created by the Group Coordinator using the Coordinator Device or the Group Support Application and transmitted to the System Controller.

The system may be designed to compare incoming messages to the stored rule type to determine message type before transmitting the message to a Coordinator Device, Member Device or Support Group Application. It may also be designed to identify message type on the Coordinator Device before being transmitted to the Support Group Application.

The system may be designed to compare message content to the rules stored on a database on the Coordinator Device or System Controller that determine how the message can be interpreted. Messages may be designed to contain codes that enable the system to interpret its meaning.

A code is defined herein as a set of standardized signals and/or characters that may be used to communicate between multiple Member Devices, or between a Coordinator Device, Member Device and the System Controller. Interpretation may be based on text content and/or formatting:

A text message short code that indicates that the result of a call was “All medications were taken today,” (e.g. reply to *123456) or “Some medications were taken today, (e.g. reply to *111222) or “No medications were taken today” (e.g. *000111).

A letter or number in a text message that signifies whether the patient took all medications, e.g. “A” or “1”, some medications, e.g. “S” or “2” or no medications, e.g. “N” or “0”.

A combination of consecutive letters, numbers, symbols or graphics that signal answers to questions or instructions in previous prompts, e.g. “YYY”=the patient took all three medications, “YNY”=the patient took the first and third medications on the list, but not the second, or for example, “Y/N”=the patient took the first medication, part of the second medication, but not the third medication.

Keywords that appear within the body of the message, e.g. “YES” or “nausea”.

The position of a set of one or more signals or keywords within a message body, e.g. first word “YES” means the call was complete. Second word “YES” means the patient took all medications as prescribed. Last word “DIZZY” would be stored in a database on the System Controller as feedback provided by the patient.

The order within multiple messages sent, as in one example where the first message contains simply a “YES” or a “NO” to signify whether or not a call has been made, a second message contains “COMPLETE” to indicate that all medications were taken, and a third message that contains three words separated by a comma “dizzy,nauseous,sleepy” to indicate side effects the patient has reported to the group member.

Such messages may be sent in response to prompts sent to a Member Device via the Support Group Application, System Controller, or Coordinator Device.

The Support Group Application may log the message, and may update the status of a prompt as expired or unexpired on the Coordinator Device, based on interpreting the contents of the message.

A Support Group System may automatically determine the message type and interpret the message, however it may require the Group Coordinator's confirmation. Additionally, the Group Coordinator may be able to change any the determination or interpretation of messages done automatically be the system's software.

Determine output, based on interpretation of message

The system may be designed to respond to incoming messages in a variety of ways, depending on what type of message is received and how it is interpreted.

In one example, the system may respond to a single message, based on its interpretation of the message contents and message type.

E.g. In response to an availability message of “No, I am busy,” the system may prompt the Group Coordinator to send a new message to one or more of the registered cell phones on the roster to determine availability to complete the task. Additionally, the system may repeat this step automatically until it receives a message that matches the rules defined in the rules database, e.g. “in response to an availability request, look for a confirmation message.”

E.g. In response to a message the system interprets as a confirmation, the system may send a message, such as a reminder or updated status to a Group Member or Group Coordinator.

E.g. In response to a message the system interprets as a confirmation, the system may identify the next incoming message as a different message type, as defined in the rules stored in the rules database on the System Controller or local device.

In one example the system may respond based on not receiving a message,

E.g. Displaying or Sending a reminder to the Coordinator Device if no response to an availability message is received from a specific group member within 3 hours of the end of a prescription compliance time period, as defined in the rules database for this task and message type.

E.g. Automatically sending out a reminder to a Member Device if no status message has been received prior to the end of a prescription compliance time period.

E.g. Sending out messages to one or more Group Members when a change in expected protocol occurs, such as changing from one confirmed Group Member to another one for a scheduled Support Group Task. Upon such a change, the system might be designed to send out one or more messages to one or more members of the group to ensure that the Support Group Task is completed.

Additionally the system may determine what type of message to send out or prompt to display based on which member of the roster the system expects to receive a message from for that Support Group task. The system may determine this by utilizing rules in the database and stored in the profile details as described in the Roster Creation step above.

In another example, the system may determine when and how to respond based on receiving multiple messages.

E.g. Sending a prompt to one or more Group Members if a certain number of negative results messages are processed within a designated number of time periods, e.g. a week.

E.g. Sending a prompt to one or more Group Members if multiple messages contain certain keywords, such as three messages containing the word “Nausea”

E.g. Sending or posting a report to one or more Group Members periodically or after receiving a designated number of messages. Additionally, the system may send a report at the manual initiation of the patient or Group Coordinator.

Update Support Group Database

The system may record all data that comes through the system in one or more databases stored on a local device or the system controller. Examples of data that may be stored includes:

A history of inbound and outbound messages

The content of a message

Any data stored in the system may also be associated with tags and identifiers such as Support Group ID, Task Type, unique Task ID, Patient Profile Information, message ID, message type ID, privacy indicators, task completion indicators, or third party affiliations

Data saved on the system may be accessed by various entities. The extent of access is determined by the type of entity. For example, the Group Leader may have full access to all information stored in the Support Group Database, whereas a Group Member may not be able to view contact details of another Group Member. In another example, a third party partner may have access to data stored in the system, so long as personally identifiable information, such as Patient Name is not included.

### 3. Example #D3

The following process is descriptive of Groups, Group members, Group Coordinators and messages sent by each through a Support Group System. The establishment of a Support Group, its members, and a description of the Support Group System has been discussed in earlier sections/examples of this document. It is contemplated that such steps/description may be used to enable the following process steps.

The process steps in Example #D3 (as well as others herein) are contemplated as a management system for handling all types of messages from a Group Member (e.g., Support Group Task Availability, Support Group Task Status/Results, Support Group Task Completion, and Support Group Task Details) and can be used for messages related to all types of Support Group purposes, as described in other examples herein. Many examples provided below are described in the context of one specific use of the Support Group System: Monitoring Prescription Compliance. However, it is important to consider that when the Support Group System is not only contemplated for Monitoring Prescription Compliance and may be used by a support group to Manage a wide range of everyday tasks or problems such as picking up groceries or finding someone to talk on the phone with. It may also be used to manage recurring, everyday tasks like monitoring prescription compliance, such as completing homework, picking up children from school, monitoring a diet, supporting a target who has quit smoking, etc.

In one example, a Support Group may be assembled by a Group Coordinator to monitor the Group Target's adherence to a prescribed medication regimen. The Group Coordinator sends out Support Task Requests each day to ensure that one Group Member calls the group target to determine if they've taken that day's dose of medicine. In such an example, the system can be used not only to track daily compliance, but also to track and process additional feedback regarding the patient's compliance, such as reasons for non-compliance. One way to use a Support Group System for this purpose is discussed below in the following process steps: Receive a message from a Group Member, Determine whether to request another message from the group member, Receive Task Feedback Message from the Group Member, Process Task Feedback Message, Determine if an escalation is required based on Reported Task Feedback, and/or Perform escalation event.

Receive a message from a Group Member: The system may be designed to receive more than one message or message types from an individual Group Member, each of which may be related to one single support group task. For example (and as is also described in Example 2 and Example 3, above) a single group member may send multiple messages to the system and the Group Coordinator providing information about a specific support group task. Each message or message type may provide the system or Group Coordinator with different types of information. Additionally, one or more of these messages may follow a protocol such that they can be automatically interpreted by system software.

One possible type of message from the Group Member may indicate whether or not the member is available to perform a support group task. E.g., “Yes”. E.g., “No, I am busy today”.

One possible type of message from the Group Member may indicate whether or not a task has been completed. E.g., “Complete”. E.g., “I've Called Grandma”.

One possible type of message from the Group Member may indicate a status or result of a task; E.g., “Yes, I've picked up the groceries”, E.g., “Yes, Grandma has taken her medication”, E.g., “No, the dog did not go out today”, E.g., “No, Grandpa did not take his medication”.

One possible type of message from the Group Member may indicate Support Group Task Feedback—additional details about the task. E.g., “Grandma said she was nauseous”. E.g., “Ben only took the green pill, he forgot to take the blue one”. E.g., “I picked up Sally from school, but Timmy has detention and has to be picked up at 4:45”.

Message Processing: In one example, the system may be designed to receive one or more of these types of messages in a defined order. In such an example, the receipt of a first message or message type may trigger the system to store or process a second message in a manner different from the first.

E.g., a first message received from the Group Member comprises the word “Yes”. Because it is the first message received from the group member, the system interprets the message as an indication that the Group Member will be able to perform a support group task. A second message received from the Group Member is “Yes”. Because it is the second message received from the group member, the system interprets the message as an indication of the result of a task.

In another example, the system may be designed to interpret the type of message based on the message's content. In other words, each type of response may require the Group Member to reply using protocol specific to that message type.

E.g., a first message type requires the group member to reply either “Yes” or “No”, which indicates whether or not the Group Member is available to perform a support group task. Additionally, a second message type requires the group member to respond “complete” or “incomplete”, which indicates whether or not the Group Member has completed a task. At any time, if the Group Member sends a message using any one of these words, the message may be determined to be of the type that uses that protocol. Additionally, if the Group Member sends a message that does not use these words, then the system may perform another action, such as asking the member to reply using a correct protocol, forwarding the message directly to the Group Coordinator, determining the message is a different type that does not require a protocol (e.g., a message providing supplemental task information), etc.

In another example, the system may be designed to allow the Group Coordinator to receive and process a message received from a Group Member.

E.g., a first message received from a Group Member comprises the word “Yes”, and the Group Coordinator indicates to the system (e.g., through the Support Group App) that the Group Member is available to perform a support group task. A second message received from a Group Member comprises the word “Yes” and the Group Coordinator indicates to the system that group's target has taken a prescribed medication as directed.

Alternatively, a Support Group System may automatically determine the message type and interpret the message, however it may require the Group Coordinator's confirmation. Additionally, the Group Coordinator may be able to change any the determination or interpretation of messages done automatically be the system's software.

Either software on the System Controller or the Support Group Application may be responsible to for receiving and processing messages as described above. The Support Group System may store the message and the message's interpretation.

Determine whether to request another message from the group member: Once the system has received a first message (e.g., one of the type discussed above) the system may determine whether or not an additional message from the group member is required.

In one example, the system may determine that a particular Support Group Task requires that the Group Member sends more than one message. If the required amount of messages has not been sent, then the system may make the determination that an additional message is necessary. In such an example, the task may be defined such that x amount of messages are always necessary.

E.g., a message received indicates that the Group Member is available to perform a Support Group Task. The System then determines that the Group Member needs to send an additional message indicating the result of the support group task (e.g., “Yes, Grandma took her medication).

The requirement for multiple messages may have been established by the Group Coordinator when setting up a Support Group Task using the Support Group Application

E.g., Group Coordinator selects that a message needs to be sent by the Member to confirm availability and when the task is completed. E.g., Group Coordinator can customize the # of messages that are required, as well as how they are interpreted (automatically or manually) and any protocol or instructions associated with the Support Group Task.

In one example, the system may determine that a particular Support Group task requires an additional message based on one or more of the responses received from a Group Member.

E.g., a message comprising the word “Yes” may not require any further messages, whereas a message comprising no may not require any further messages from the group member. E.g., a message comprised of “No” indicating that a task has not been completed may require further information from the Group Member about why the task is incomplete. E.g., a message comprised of “No” indicating that the result the task was negative (e.g., Grandma did not take her medication, the member did not go to the grocery store) may require further information from the Group member about why the result was “No” (e.g., Grandma forgot, the store was closed).

The Support Group System may send a message to prompt the Group Member to send an additional message when necessary. Prompt may be sent automatically by the system. Whether or not to send prompt may be determined based on a set of rules stored in a Support Group profile.

E.g., the Group Coordinator defines when to send out a prompt for additional messages. E.g., the Group Member defines when he or she would like a prompt for additional messages. E.g., the Prompt is only sent out if not message is received by a specific amount of time. E.g., x time after the previous message was sent. E.g., x time of day

Prompt May be sent out manually by the Group Coordinator: System may ask the Group Coordinator “would you like to send out a prompt to the group member?”

Prompt may be template: Prompt may be modified or composed by the Group Coordinator.

Prompt Examples: “In a short message, please tell us why the patient was non-compliant”, “In a short message, please tell us why you were unable to perform the Support Group Task”, “Don't forget to send a message by 2 PM saying “Yes” for compliance and “no” for non-compliance”, “Please Respond “complete” by 8 PM, to inform the Group Coordinator that the task has been completed”.

In some examples, the Support Group System may not send out a message to prompt the group member to provide more information. Instead, he or she may be expected to do so based on a previous message or instructions received from the system or Group Coordinator.

Receive Task Feedback Message from the Group Member: As discussed in the previous steps, Support Group Task Feedback may be received in response to a prompt from the system and may be required only in a subset of Support Group Tasks performed by the Support Group.

Task Feedback is information that is sent through the system that provides details about a performed (or unperformed) task. In one example, Task Feedback is used by Group Members to provide more context than a message following a protocol is able to (i.e., its more than just “No”).

Examples of Task Feedback: “Elise stopped taking her medication because it is making her nauseous”, “Tony missed taking the second pill because it gives him headaches”, “Scott went away for the night and forgot to pack his medication”, “Grandma took all of her pills today, and she's in a great mood because her cat is healthy again!”, “I have a doctor's appointment today, sorry I cannot go out after work”, “I'm driving right now, can't talk”.

Other Message+Task Feedback: In one example, Task Feedback may not be sent as a massage independent of another message. In other words, two types of messages; E.g., Task Feedback Message may be included in the first message from the Group Member; E.g., in the message “No, Jon was not feeling well today”, “No” is interpreted automatically by the system and indicates noncompliance and “Jon was not feeling well today” is additional feedback regarding why Jon was noncompliant.

In one example, the System may be designed to automatically consider message content falling outside of the protocol as Task Feedback. In such an example, any time a message is received that does not follow message protocol it is stored/forwarded to Group Coordinator under the auspices of “Task Feedback”.

In another example, the Support Group System may require Task Feedback, and in fact may alert the Group Coordinator or remind the Group Member if it is not received by a threshold time period—see examples, above, for more information about how un-received messages are resolved.

Task Feedback is not the only type of message that can be combined with another message. In fact, some embodiments of the present system may require that the Group Member provide content related to multiple message types in one message.

For example: A message received from a Group Member may be “Yes, Yes.” In such a case, the Support Group System may recognize that the first “Yes” indicates that the task is complete and the second “Yes” indicates that Grandpa took is medication.

In one example, Task Feedback is sent directly to the Group Coordinator's device and is received by the Support Group application. In another example, Task Feedback is first sent to the System Controller and is then forwarded to the Group Coordinator Device.

In another example, a Task Feedback message may not be a freeform message; rather it may follow a protocol and be automatically interpreted by the system. E.g., a Group Member may respond “1” for noncompliance due to nausea, “2” for noncompliance due to headache, and “3” for any other reason (which may be input in a freeform fashion).

It should be noted that though the examples above focus on prescription compliance, Task Feedback may be used for Support Groups not focused on Prescription Compliance; E.g., “no, the store was closed”; E.g., “yes, but Jonny has to stay after class, I only picked up Susan”; E.g., “no, but I only smoked one cigarette today”; Process Task Feedback Message.

In one example, Task Feedback may simply exist as supporting information to the Group Coordinator, and may be ignored by the system. In another example, Task Feedback may be relevant or even central to the Support Group's purpose, and therefore means for reporting, storing and processing Feedback information may be a part of the Support Group System. In another example, Task feedback is reported and stored by the Support Group System.

Manual Reporting: In some examples, the content of Support Group Task Feedback may not follow a specific message protocol (e.g., write “Y” for compliance and “N” for non-compliance) and may therefore message content may be unanticipated. The wide range of content that may be sent in a Task Feedback Message may therefore make automatic interpretation difficult or impractical.

In some examples the Group Coordinator may be relied on to process incoming Task Feedback messages by taking on the responsibility to report the Feedback to the system. E.g., all feedback is received on the Group Coordinator Device and input by the Group Coordinator

Freeform Reporting: In one example, Group Coordinator may determine what (if not all) content from a Task Feedback Message to report. Task feedback may be entered in a freeform format, such as text, a voice recording, video, etc. In another example. The Group Coordinator may determine whether or not it is appropriate to submit (forward) a Task Feedback message. (I.e., the Group Coordinator may verify or validate Task feedback before submitting to system).

In one example, the Group Coordinator may combine content from multiple Task Feedback messages and report all at once. Task feedback may be entered in a freeform format, such as text, a voice recording, video, etc. In another example, the Group Coordinator may pick one or more Task Feedback messages from a set to upload.

Formatted Reporting: In one example, the Group Coordinator may use a structured format when reporting Task Feedback to ensure that the information is standardized; E.g., standardized reporting may prevent “nauseous” and “sick to his stomach” from being recognized as different side effects by the system; E.g., standardized reporting may allow a Group Coordinator to make a severity indication: How severe is a headache? How often is she fainting? How long is the stomach ache lasting?

The Group Coordinator may interact with a Reporting Interface in order to report data. A Reporting Interface is a tool that the Group Coordinator can use to report Feedback data. A Reporting Interface may be generated and presented based on stored information about the Support Group, the Group's Target, a prescribed medication, the Support group task, etc.

In one example, the system determines relevant side effects that may be reported by a Group Member based on the condition the Target has and the Medication the Target is on. A Group Coordinator may interact with a Reporting Interface in any number of ways to indicate Feedback. In one example, the Interface may be a checkbox with a list of potential reasons for not taking a medication. In addition, a freeform text box may exist for reasons that don't appear on the list. The Group Coordinator may also be asked to provide additional information, such as the severity of a side effect or symptom.

Group Coordinator may access the Reporting Interface in one or more ways: Pushed—Reporting Interface is displayed to the Group Coordinator based on a trigger, such as when the Group Coordinator Device or the System Controller receive a Task feedback Message; Pulled—Reporting Interface is displayed to the Group Coordinator in response to a request to report from the Group Coordinator. E.g., the Group Coordinator selects a “Create a Feedback Report” option; E.g., the Group Coordinator accesses a “Feedback Reporting” area of the Support Group App.

Reporting interface may be presented on a Group Coordinator Device through the Support Group Application

Reporting interface may exist remotely (e.g., on a webpage) and accessed using a Coordinator Device or another device in communication with the System Controller.

Automatic Reporting: In one example, software is used to automatically interpret a received Feedback message. For instance, keywords (e.g., nausea) may be searched for and automatically recognized and reported when detected in a Task Feedback Message.

Coordinator Confirmation: A coordinator may be required to confirm that the software program has correctly interpreted a received Feedback Message. E.g., “Please confirm that the Patient did not take the medicine because they felt nauseous.” A coordinator may be able to cancel or invalidate Feedback

Storing Task Feedback: Reported Task feedback may be stored locally (e.g., on the Group Coordinator Device) or remotely (e.g., on the System Controller) in association with the Support Group. As discussed elsewhere herein, information from all message types may be stored by the System. Some examples include: The Group Member that performed a task, Whether the Group Member completed a Task, A status about the Task (e.g., successful?, Compliant?, etc.), Task Feedback or additional information received in a message about a Task.

Rules for privacy controls regarding all or a part of stored information may govern who has access to stored Support Group Information. E.g., Group Coordinator, Group Member, Group Target, 3^{rd} Party company, medical professionals, etc.

Determine if an escalation event is required occurs based on Reported Task Feedback: In one example of the Support Group System, an “Escalation Event” may be required based on the content of Task Feedback. For example in the case where a Support Group is monitoring a Target's prescription compliance, Task Feedback may include information about a reason that a Target refuses to take the prescribed medication. Such Task Feedback may include potentially dangerous side effects or symptoms of a condition may be reported. In such a case, the system may be designed to detect and trigger a reaction to address a potentially problematic situation. Escalation Rules Database: There may be database that stores rules for when an escalation event should occur. This database may be consulted by the system when determining when. For instance, the escalation database may state that if the word “dizziness” appears in the Task Feedback there. There following may be example components of an escalation rule

Escalation Trigger: Escalation Trigger Source (e.g., message type, task history, task status etc.). Required action (the escalation event).

Rules can be defined by: The System, Support Group System Employees, Group Candidate, Group Target, A third party company (e.g., a pharmaceutical company, pharmacy), A medical professional (e.g., a doctor).

Automatic Detection and Escalation: Software in the system may monitor incoming Task Feedback and automatically detect when an action is required. For example, the system may look for keywords in Task Feedback that may indicate a situation that requires further action. E.g., Task Feedback might indicate that the target did not take a medication because it makes them feel dizzy. The system may know that dizziness is a potentially serious side effect of the prescribed medication based on information stored in a medication Database. The System may then trigger an escalation event. E.g., Task Feedback might indicate that two children were not picked up from school. The system may know that three children were supposed to be picked up based on information stored in a Support Group Profile or a definition of a Support Group Task. The System may then trigger and escalation event.

Once software has detected a situation requiring further action, the feedback may be passed on to an employee of the system to confirm that further action is necessary.

Manual Detection and Escalation: Employees of the system may monitor incoming Task Feedback and determine if a situation in exists that warrants additional action in the system. Escalation Events may be based on information stored on the system providing information about the Support Group.

For example, in a case where the Support Group System is monitoring feedback pertaining to prescription compliance, the triggers for an escalation event may be based on the type of medication that is being taken and the type of condition that the target has.

In a similar example, a system with multiple Support Groups each using the support group system, and each monitoring compliance for targets who have different medications and/or different prescriptions. Side effects that may be dangerous for one target may not necessarily be dangerous for another.

The types of information about a Support Group considered for escalation purposes may include, but not limited to: Target Profile information, Medication taken by a Target; Health condition a target has; Demographic information; Support Group Profile information; Purpose of the group; Size of Group; Support Group Task; Task description; Task periodicity; Group Member assigned to the Task; Task requirements; Group Member Profile information; Demographic information; Task Schedule information; Availability information.

Perform Escalation Event: Once it has been determined that an escalation event is required, the system may perform any number of escalation events as may be necessary to the situation. Some examples of escalation events include:

Data Collection/Processing Modifications: The System may recognize that more or different information is needed from the Support Group. In one example the extra information may lead to the determination of whether further escalation is needed or not. In another example, the extra information may help define a message received earlier

The System may recognize that more information is needed based on detection of one or more escalation triggers described above. The System may make a determination of what type of additional information is necessary. e.g., further questions based on profile information

The patient profile says the target has insomnia, is this still an existing condition? What medication, if any is she taking. The profile says the target is taking codine as well—what dose is she taking? e.g., further questions as a reaction to a reported side effect. Is the target taking this medication with food? When is the target experiencing the side effect? How often does this side effect occur? How severe is this side effect on a scale from 1-10.

The system may output a message to one or more of a Group Coordinator, a Group Member, a Group Target, an entity associated with the Support Group (e.g., a doctor) etc. Additional information may be received and processed by the system as a message or an input into a reporting interface. Detailed description of receiving and processing such information is discussed in the previous steps of this process. Additional Information may therefore be handled in a similar manner to Task Feedback information.

Emergency Alerts: In one example, a message may be sent by the system alerting the recipient that there may be a problem that should be addressed.

One or more of the Group Coordinator, Target, Group Members, a doctor, etc. may receive a message from the system regarding the problem.

The Message may include a variety of information automatically pulled from a database, such as: Details of the Problem, Suggestions for how to resolve the problem, Information related to one or more of the Support Group, a Support Group Task, the Group Member, the Group Coordinator, the Group Target, etc.

The message may be interactive in that it provides resolution options that trigger further action when selected by the recipient; E,g., “Contact Medical Personnel”; E.g., “Send a Message to the Target”; E.g., “Call the Target”; E.g., “Send a Message to a Group Member”; Alert Emergency Medical Personnel; Emergency; Forwarding Medical “report”; Including Feedback History, Profile info, Compliance patterns, etc.

### 4. Example #D4

The following example describes an embodiment wherein a Support Group Service is provided to Groups, Group Members, Targets and Group Coordinators. A Support Group System (System) manages a software application and/or website that Group Members and Group Coordinators use to interact with the service. The System also manages work flows and processes that control inbound and outbound communication to and from Group Members, Group Coordinators, Targets, and Support Group Employees called “Nurses”. Nurses and their functions are described in more detail below.

One purpose of the Support Group Service (Service) is to help a Target accomplish a daily task. This Example #D4 focuses on one exemplary task (Prescription Adherence) but may be applied to any other task. Such a service might fulfill the following, broad and exemplary functions: Establishing a Support Group and a group Target, Inviting people to join the Support Group, Receiving a response to a Support Group invitation.

Scheduling at least one member to call the group Target each day, may include but may not be limited to: Attempting to contact the one or more scheduled group members a first time, Receiving a response from one or more of the group members, Determining whether to attempt to contact the one or more scheduled group members a second time, Receiving a response from one or more of the group members, Determining whether or not to contact a Group Coordinator, Determining whether or not either the Group Coordinator or a Group Member is going to call the group Target, Scheduling a call From a Nurse if neither the Group Coordinator or a Group Member is going to call the group Target.

Receiving and tracking call information, including but not limited to: Was the Caller's availability confirmed? Who called? Who is scheduled to call? What was the result? (e.g., did Target take all, some, or none of the medication), Providing call information to the Group (Members, Coordinator, Target), Managing payment for the service from one or more of the Group Members, Coordinator, Target.

In order to accomplish the above, the system interfaces with a network of Support Group Service Employees who are available to call the Target when Group Members are unable to. Herein, these employees are referred to as “Nurses”, because they are described in the context of a service helping Targets adhere to a prescribed medication regimen. However, these employees may be any person of any profession that may be appropriate or desirable for a particular service. For example, if the service is designed to organize people to call an elderly person who lives alone, the employee may be a counselor. In another example, if the service is designed to organize people to call someone who is trying to stick to a diet, the employee may be a nutritionist. Such employees may be free lance workers who are contacted for piecemeal work, or may be more formal workers making calls out of a call center run by the Support Group Service.

The System is responsible for many types of communication. For example, the description frequently refers to calls made to a Member, Target, or Coordinator. It is of course contemplated that such communication may occur using other available methods as well, such as email, SMS, MMS, VoIP audio or video chat, Instant Message, etc. Similarly, phones or computers are not the only type of device suitable for interaction with the service—any device described elsewhere herein or that becomes appropriate may be used as well.

### 5. Example #D5

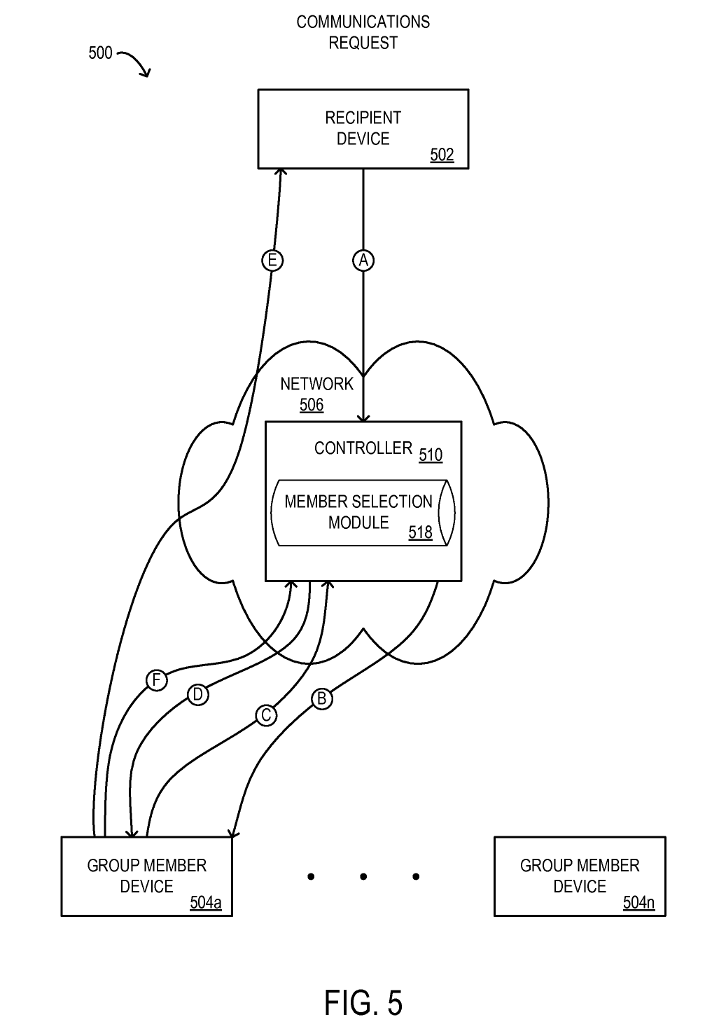

Turning to FIG. 5, a block-flow diagram of a system process 500 according to some embodiments is shown. In some embodiments, the system process 500 may performed and/or implemented by and/or otherwise associated with one or more specialized computers, computer terminals, computer servers, computer systems and/or networks, and/or any combinations thereof (e.g., such as by the systems 100, 300 of FIG. 1 and/or FIG. 3). In some embodiments, the system process 500 may be implemented via various components such as depicted in FIG. 5. The system process 500 may be implemented by, for example, a recipient device 502, one or more group member devices 504a-n, a network 506, and/or a controller 510. In some embodiments, the controller 510 may comprise a member selection module 518. According to some embodiments, any or all of the components 502, 504a-n, 506, 510 of the system process 500 may be similar in configuration and/or functionality to the similarly named and/or numbered components described with respect to the systems 100, 300 of FIG. 1 and/or FIG. 3 herein. Fewer or more components and/or various configurations of the components 502, 504a-n, 506, 510, 518 may be included in and/or utilized to implement the system process 500 without deviating from the scope of embodiments described herein

In some embodiments, a recipient may transmit a communication request, such as via the recipient device 502 to the controller 510, via “A”. The controller 510 may utilize the member selection module 518 to automatically select one of a plurality of group members to whom the communication request should be sent. As depicted in FIG. 5, for example, a communication request may be sent to a first group member device 504a, via “B”. The first group member device 504a may confirm availability via “C”, and/or the controller 510 may instruct the first group member device 504a to contact the recipient, via “D”.

In some embodiments, the first group member device 504a may be utilized to contact the recipient via the recipient device 502, thus satisfying the communication request, via “E”. According to some embodiments, the first group member device 504a may provide post-communications feedback (such as compliance and/or task progress information) to the controller 510, via “F”.

### IV. Interface Structure

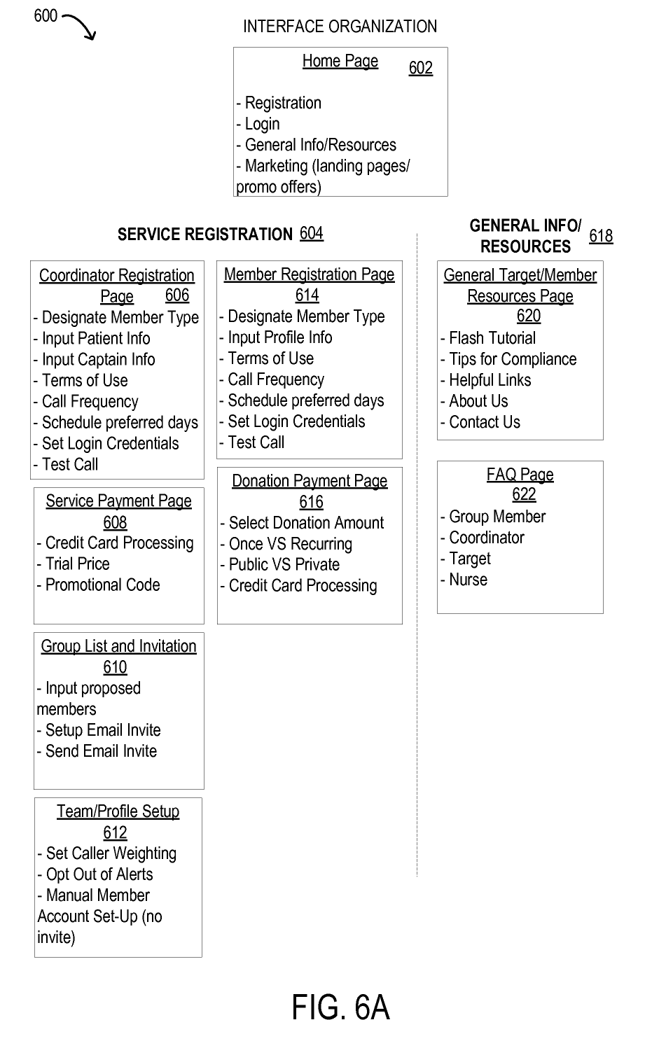

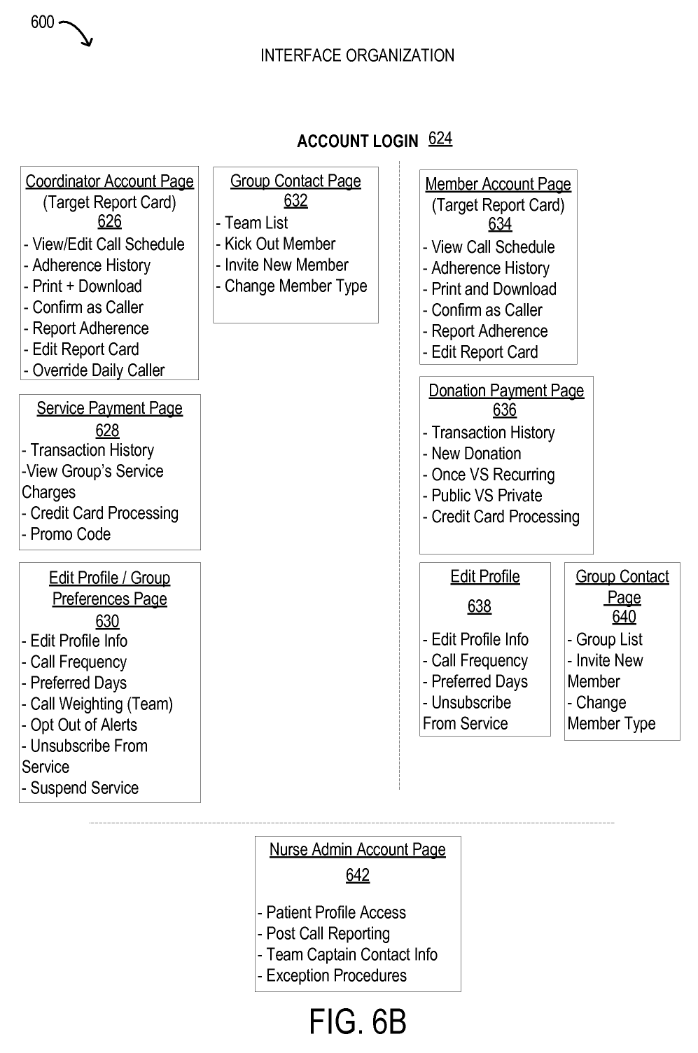

Turning now to FIG. 6A and FIG. 6B, an exemplary interface structure 600 in accordance with some embodiments is shown. The interface structure 600 may, for example represent a framework for a structure of a set of web pages and/or application interface pages or screens via which a user may facilitate group communications as described herein. FIG. 6A and FIG. 6B, for example, may depict an exemplary way that pages of a group communications service software application or website might be laid out. Such a software application or website may allow Group Members, Coordinators or Targets to interact with the Service. The following section describes a variety of features and functionality that may be included. The organization of pages and the features and functionality on each page may be modified in any number of ways, this is simply one example of the application/website.

As shown, in some embodiments the interface structure 600 may comprise a home page 602 and/or a series of service registration pages 604. The service registration pages 604 may comprise, for example, a coordinator registration page 606, a service payment page 608, a group list and invitation page 610, a team/profile setup page 612, a member registration page 614, and/or a donation payment page 616. The interface structure 600 may, according to some embodiments, comprise a general information/resources series of pages 618, such as a general target/member resource page 620 and/or a Frequently Asked Questions (FAQ) page 622. In some embodiments, interface structure 600 may comprise a series of account login pages 624, such as a coordinator account page 626, a service payment page 628, an edit profile/group preferences page 630, a group contact page 632, a member account page 634, a donation payment page 636, an edit profile page 638, a group contact page 640, and/or a nurse admin account page 642.

The home page 602 may, according to some embodiments, be described as follows:
Registration: May provide paths for both a Group Coordinator to Create a Support Group and for a Group Member to Register and Join an existing Support Group;
Login: User may be able to log into an account using email address and password. Logging in sends the User to an Account page;
General Info/Resources: may link the User to general information that may be accessed without logging in;
Marketing: A dynamic space that may be used by the Service to promote the service, provide discounts, advertise updates, etc.; and
Nurse Admin Log-in: May provide Staff Nurses with access to an admin account interface. Login may not be hosted on the homepage—if it is, it may be inconspicuously positioned.

The coordinator registration page 606 may, according to some embodiments, be described as follows:
Designate Member Type: Coordinator can indicate whether she'd like to participate as a:
Caller—members scheduled by the system to call the Target each day, OR
Supporter—members that contribute to paying for the service only, OR BOTH;
Input Target Info: Several fields may be used to collect Target profile information, such as but not limited to:
Full Name
Gender;
Primary (+Optional Secondary) Phone number;
Mailing Address;
Can the Target Speak English?; and
State;
Input Coordinator Info: Several fields may be used to collect the Coordinator's information, such as but not limited to:
Full Name;
Primary (+Optional Secondary) Phone number;
Gender;
State;
Relationship to Target; and
E-mail Address;
Terms of Use: Coordinator may be presented with terms of use, for which she may have to indicate acceptance before proceeding;
Call Frequency: The Coordinator may submit the upper bound of how many times per month she is willing to call the Target. This is taken into account when the system schedules daily callers;
Schedule Preferred Days: The Coordinator may be able to indicate days of the week she is generally unable to make calls. This may be taken into account when the system schedules daily callers;
Set Login Credentials: Coordinator may set a Password (email address is username); and
Test Call: The Coordinator may be asked to store the Support Group Service 1-800 Number in her phone. The Coordinator can then trigger a “test call” and confirm that the number is stored appropriately.

The service payment page 608 may, according to some embodiments, be described as follows:
Credit Card Processing: The Coordinator may submit her credit card information to pay for the service;
Trial Price: The Coordinator may be offered a trial price for the first month of service, which discounts the cost of the base service and provides a number of Free Staff Nurse Calls; and
Promo Code: The Coordinator may be able to enter a promotional code (if she has one) that activates special pricing, features or account grouping.

The group list and invitation page 610 may, according to some embodiments, be described as follows:
Input Proposed Members: Group Coordinator may be able to submit a list of individuals she would like invited to the Support Group. Information collected might include names and contact information;
Setup Email Invite: Coordinator may be able to add a personalized message that is inserted into a template invitation; and
Send Email Invite: The Coordinator may be able to confirm and submit an invite list that the system uses to distribute invites to each proposed member. Each invite includes a link that sends the recipient directly to a registration page.

The team/profile setup page 612 may, according to some embodiments, be described as follows:
Set Caller Weighting: The Coordinator may be able to set a preference on how frequently each member is scheduled by the system to call the patient;
Opt out of alerts: The Coordinator may be able to indicate if she'd like to receive alert messages when a Group Member declines or does not answer the Daily Call Request; and
Manual Member Account Setup: The Coordinator may be able to set up a team member account manually by filling out the necessary member registration information (See Member Registration Page 614).

The member registration page 614 may, according to some embodiments, be described as follows:
Designate Member Type: Members may indicate whether they'd like to participate as:
Callers—members scheduled by the system to call the Target each day, OR
Supporters—members that only contribute to the Group Fund, thereby helping to pay for the service, OR
BOTH;
Input Profile Information: Several fields may be used to collect the Member's information, such as but not limited to:
Full Name;
Relationship to Target;
State;
Phone Number(s); and
E-mail;
Terms of Use: Coordinator may be presented with terms of use, for which she may have to indicate acceptance before proceeding;
Call Frequency: The Member may be able to submit the upper bound of how many times per month she is willing to call the Target;
Schedule Preferred Days: Member may be able to mark any days of the week she is generally unable to make calls;
Set Login Credentials: Member sets a Password (email address is username); and
Test Call: The Coordinator may be asked to store the Support Group Service 1-800 Number in her phone. The Coordinator may then be able to trigger a “test call” and confirm that the number is stored appropriately. NOTE: Group Member may arrive at registration through a hyperlink on an e-mailed invite. If the Member comes through the Homepage 602 instead, she may have to indicate which team she is joining (through a Group ID in the Invite).

The donation payment page 616 may, according to some embodiments, be described as follows:
Select Donation Amount: Member may be able to select how much money she wishes to donate to the Group Fund;
Once VS Recurring: Member may be able to choose to make a one-time donation or to have monthly donations automatically charged;
Public VS Private: Member may be able to choose to make the donation Private (i.e., anonymous) or Public (i.e., viewable by other members); and
Credit Card Processing: Member may input credit card information for processing. Credit Card info is saved, however only the last four digits can ever be seen by a logged in user.

The general target/member resource page 620 may, according to some embodiments, be described as follows:
Flash Tutorial: Promotional video/interactive tutorial that shows prospective customers what the Service is all about and how it works;
Tips for Adherence: A list of helpful tips to keep the patient on her meds;
Helpful Links: A page of links to outside resources on useful medical information;
About Us: Who we are and why we are working on this; and
Contact Us: Link to sending us an email.

The FAQ page 622 may, according to some embodiments, be described as follows:
Group Member FAQs: Common Q&A for Group Members;
Group Coordinator FAQs: Common Q&A for Group Coordinators;
Group Target FAQs: Common Q&A for Group Targets; and
Nurse FAQs: Common Q&A about our nurses and Nurse Calls.

The coordinator account page 626 may, according to some embodiments, be described as follows:
Target Report Card: Information may be presented in a calendar style layout, which may be printed or downloaded as a PDF. The Target Report Card may include, but is not limited to:
Who called (or is scheduled to call in the future);
Whether the Target was compliant each day;
Text notes associated with any day; and
High-level adherence statistics;
Adherence History: The Coordinator may have access to the entire history of Target's prescription adherence;
View/Edit Call Schedule: The Coordinator may be able to view the caller schedule and may be able to manually change which Member is scheduled to call for each of the next x days;
Confirm as Caller: When it is the Coordinator's turn to be the caller of the day, a call confirmation interface may be Output. She may be able to select from one of the following exemplary options: 1) Confirm, 2) Decline. If she declines, a prompt may tell the Coordinator that a Staff Nurse may call instead;
Report Adherence: The coordinator may be able to fill out a daily adherence report, which is used by the daily caller to indicate whether the patient took: 1) All, 2) Some, or 3) None of her meds. She can also provide freeform notes in a text field. When submitted, the Target Report Card is updated;
Edit Report Card: Functionality for editing the report card may exist; and
Override Daily Caller: May allows the Coordinator to indicate a desire to take over the daily caller's responsibility (in response to an Email Alert). This may also terminate attempts to schedule a Member or Nurse as the day's caller.

The service payment page 628 may, according to some embodiments, be described as follows:
Transaction History: A history of all transactions processed by the team may be seen here. May include both the Coordinator's credit card transactions and money movement to and from the Group Fund;
View Group's Service Charges: The Coordinator may be able to see how much the team owes for both individual Nurse Calls and quarterly Basic Service charges;
Credit Card Processing: The Coordinator's credit card information may be edited here (site may not show stored CC info). Any necessary payments may also be submitted via the Coordinator's credit card here; and
Promo Code: If the Coordinator has a Promotional Code that is good for a change or discount of service, she may be able to input it here.

The edit profile/group preferences page 630 may, according to some embodiments, be described as follows:
Edit Profile Info: Where the Coordinator may be able to change her profile information and password;
Call Frequency: The Coordinator may be able to change the upper bound of how many times per month she is willing to call the patient;
Preferred Days: The Coordinator may be able change the days which she does not want to be scheduled as the caller;
Call Weighting: The Coordinator may be able to set/change her preference of how frequently each member is scheduled by the system to call the patient;
Opt Out of Alerts: The Coordinator maybe able to turn on/off alert messages, which indicate when a Group Member declines or does not answer the Daily Call Request;
Unsubscribe From Service: Might allow the Coordinator to discontinue Service (i.e., stop scheduling callers and close account); and
Suspend Service: Might allow the Coordinator to temporarily stop service (i.e., stop scheduling callers).

The group contact page 632 may, according to some embodiments, be described as follows:
Group List: Might be a list of all members in the group, their membership type and contact information. May indicate how many times each member has called the Target. May also indicate the Group's ID number;
Kick Out Member: The Coordinator may be able to remove any member from the team—she may also be prompted to confirm this request;
Invite New Member: A new Member may be invited here. Full name and email address might be provided, along with an optional personal message by the inviter. System may then send an invitation to invitee; and
Change Member Type: Might allow the Coordinator to designate membership type as “Caller”, “Supporter”, or Both.

The member account page 634 may, according to some embodiments, be described as follows:
Target Report Card: Information may be presented in a calendar style layout, which may also be printed or downloaded as a PDF. The Target Report Card might include, but is not limited to:
Who called (or is scheduled to call in the future);
Whether the Target was compliant each day;
Text notes associated with any day; and
High-level adherence statistics;
View Call Schedule: The Member may be able to see who is tentatively set up as the caller of the day for each of the next x days;
Adherence History: The Member may have access to the entire history of the Target's prescription adherence;
Confirm as Caller: When it is the Member's turn to be the caller of the day, a call confirmation interface may be displayed where she can select: 1) Confirm, 2) Decline. If she declines, a prompt may tell the Coordinator that a Staff Nurse may call instead;
Report Adherence: The member may be able to fill out a daily adherence report, which is used by the daily caller to indicate whether the patient took 1) All, 2) Some, or 3) None of her meds. She may also provide freeform notes in a text field. When submitted, the Target Report Card is updated; and
Edit Report Card: Functionality to edit the report card may be available.

The donation payment page 636 may, according to some embodiments, be described as follows:
Transaction History: The Group Member may be able to see the history of how much money she, and other members, has donated to the Group's General Fund;
New Donation: The Member may be able to choose to make a new donation, selects the amount, and pay here;
Once VS Recurring: Member can choose to make a one-time donation or to have monthly donations automatically charged;
Public VS Private: Member may be able to choose to make the donation Private (i.e., anonymous) or Public (i.e., viewable by other members); and
Credit Card Processing: The Member's credit card information may be edited here (may not show stored CC info). Any necessary payments can also be submitted via the Coordinator's credit card here.

The edit profile page 638 may, according to some embodiments, be described as follows:
Edit Profile Info: A Member may be able to edit her profile information here, including password. The member can also opt out of having any optional emails sent to him;
Call Frequency: The Member may be able to change the upper bound of how many times per month she is willing and/or planning to call the patient;
Preferred Days: The Member may be able to change the days which she does not want to be scheduled as the caller; and
Unsubscribe from Service: Member may be able to remove herself from the Group (she may not be scheduled as caller anymore).

The group contact page 640 may, according to some embodiments, be described as follows:
Group List: May provide a list of all members in the group, their membership type and contact information. May indicate how many times each member has called. May also indicate the Group's ID number;
Invite New Member: A new Member may be able to be invited here. Full name and contact information may be given, along with an optional personal message by the inviter. The System may then send an invitation to invitee; and
Change Member Type: the Member may be able to designate membership type as “Caller”, “Supporter”, or Both.

The nurse admin account page 642 may, according to some embodiments, be described as follows:
Patient Profile Access: Nurses may be able to pull up information on a given Target or Group to help them conduct a call with a Target. Information may include:
Full Name;
Recent Adherence;
Meds;
Age; and
State;
Post Call Reporting: The Nurse may be able to submit an adherence report on the patient that may then be entered into the Group's Report Card;
Group Coordinator Contact Info: Might be provided in case the Nurse needs to contact the Group's Coordinator; and
Exception Procedures: The Nurse may be trained on how to handle emergency situations and may have tools enabling them to escalate a problem to proper handlers (e.g., 9-1-1; local police; Group Member/Captain).

### V. Methods

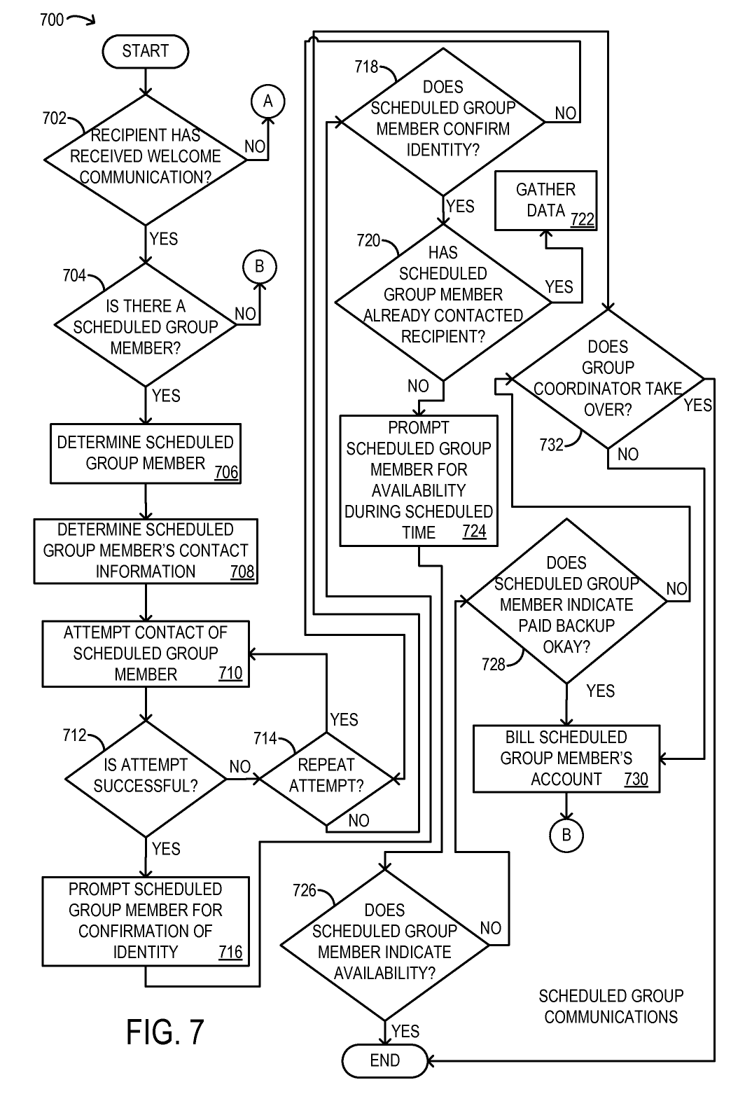

Turning now to FIG. 7, a flow diagram of a method 700 according to some embodiments is shown. In some embodiments, the method 700 may comprise a group communications method or portion thereof, such as a portion of a scheduled group communications method. According to some embodiments, the method 700 may be implemented, facilitated, and/or performed by or otherwise associated with any of the systems 100, 300 of FIG. 1 and/or FIG. 3 herein. In some embodiments, the method 700 may be associated with the system processes 200, 400, 500 of FIG. 2, FIG. 4, and/or FIG. 5 herein.

The method 700 may generally, in some embodiments, depict a variety of process flows that the Support Group System may follow when coordinating callers to call the Target each day. To do so, the system may employ an Interactive Response Unit with automated messages. In such an example, the System automatically dials a recipient's number and receives input from the recipient in response to automated prompts. Of course, the System may incorporate live callers to coordinate callers as well. Additionally, the System may be connected to a Call Center Computer Network capable of 1) outputting information to a Call Center Nurse and or 2) Capable of Connecting a Call Center Nurse with a Target. Note: All messages, phone numbers, and web site addresses used in the figures are exemplary only and may be modified in any way. Additionally, though phone calls are the primary mode of communication used in the figures, phone calls are exemplary only, and it is contemplated that any form of communication could be substituted for phone calls, such as SMS or E-mail.

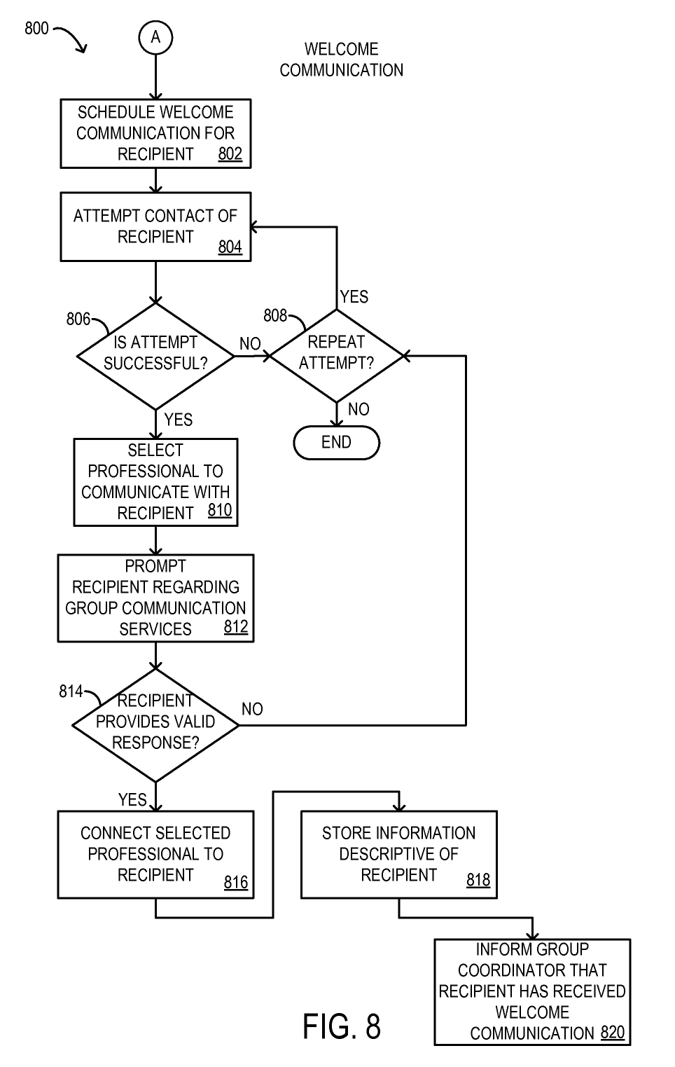

According to some embodiments, the method 700 may comprise determining if a recipient has received a welcome message, at 702. If it is determined that a welcome message has been sent/received, then the method 700 may continue to 704. In the case that it is determined that no welcome message has been sent, the method 700 may proceed to “A” (See FIG. 8, herein).

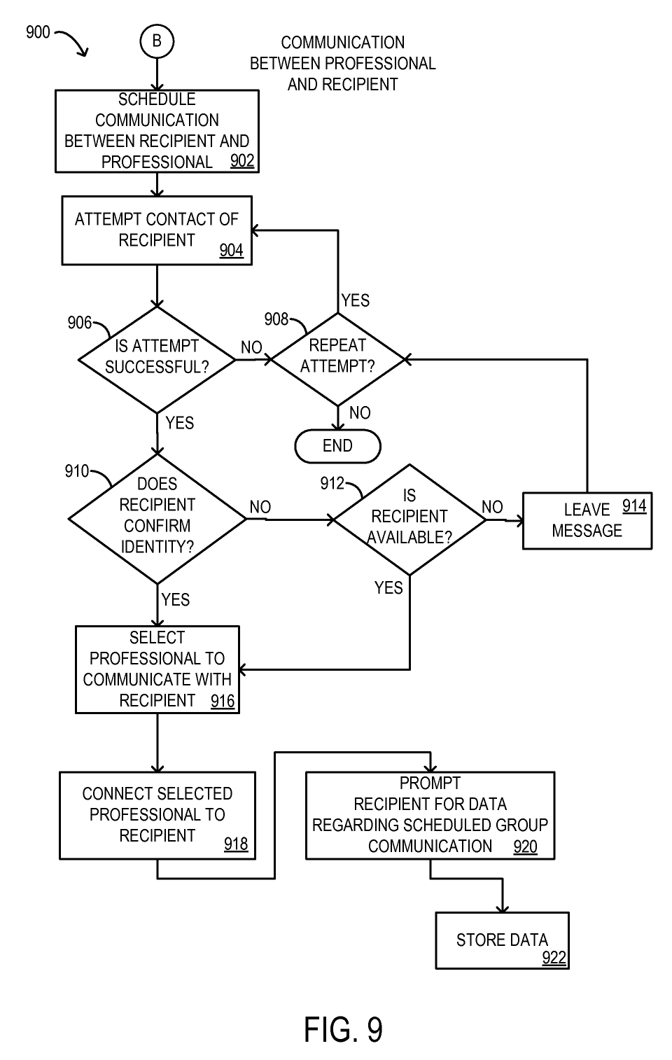

In some embodiments, the method 700 may comprise determining if a group member is scheduled, at 704. If it is determined that a group member is scheduled, then the method 700 may continue to 706. In the case that it is determined that no group member is scheduled, the method 700 may proceed to “B” (See FIG. 9, herein).

According to some embodiments, the method 700 may comprise determining a scheduled group member, at 706. According to some embodiments, the method 700 may comprise determining contact information for the scheduled group member, at 708. According to some embodiments, the method 700 may comprise attempting to contact the scheduled group member, at 710.

According to some embodiments, the method 700 may comprise determining if the attempt to contact the scheduled group member is successful, at 712. If it is determined that the attempt was not successful, then the method 700 may continue to determine whether the attempt should be repeated, at 714. In the case that it is determined that the attempt should be repeated, the method 700 may loop back to attempt to contact the scheduled group member at 710. In the case that it is determined that that no further attempt should be made, the method 700 may proceed 732, as described below.

In the case that the attempt to contact the scheduled group member was successful, the method 700 may proceed to prompt the scheduled group member for confirmation of their identity, at 716. The method 700 may comprise determining whether the scheduled group member's identity has been confirmed, at 718. In the case that the identity has not been confirmed, the method 700 may proceed back to determine if a repeat attempt should be made, at 714. In the case that the identity has been confirmed, the method 700 may proceed to determine if the scheduled group member has already contacted the recipient, at 720.

In the case that the recipient has already been contacted, the method 700 may proceed to gather data at 722. In the case that the recipient has not already been contacted, the method 700 may proceed to prompt the scheduled group member for their availability, at 724. The method 700 may comprise determining whether the scheduled group member indicates they are available, at 726. In the case that the group member is available, the method 700 may, in some embodiments, end. In the case that the group member has not indicated their availability, the method 700 may proceed to determine whether the group member indicates that a paid backup option is okay, at 728. The group communications system may, for example, provide the option to have a professional (such as a nurse) contact the recipient on behalf of the scheduled group member, for a fee.

In the case that the group member does indicate that a paid backup contact is okay, the method 700 may proceed to bill the scheduled group member's account, at 730, and then proceed to “B” (See FIG. 9, herein).

In the case that the group member does not indicate that a paid backup is okay, the method 700 may proceed to determine whether the group coordinator will take over, at 732. The group coordinator may step in to take the place of the scheduled group member, for example, such as to avoid a fee for a paid backup (e.g., a paid professional). In the case that the group coordinator does take over, the method 700 may, in some embodiments, end. In the case that the group coordinator does not indicate that they will take over the scheduled communication, then the method 700 may proceed to charge the group member's account (or the coordinator's account, or the recipient's account, or some other account) for a paid backup at 730, and then proceed to “B”.

Turning now to FIG. 8, a flow diagram of a method 800 according to some embodiments is shown. In some embodiments, the method 800 may comprise a group communications method or portion thereof, such as a portion of a scheduled group communications method. In some embodiments, the method 800 may comprise a welcome communications method. According to some embodiments, the method 800 may be implemented, facilitated, and/or performed by or otherwise associated with any of the systems 100, 300 of FIG. 1 and/or FIG. 3 herein. In some embodiments, the method 800 may be associated with the system processes 200, 400, 500 of FIG. 2, FIG. 4, and/or FIG. 5 herein.

The method 800 may, according to some embodiments, begin at “A”. The method 800 may then, for example, comprise scheduling a welcome communication for a recipient, at 802. The method 800 may also or alternatively comprise attempting to contact the recipient, at 804.

According to some embodiments, the method 800 may comprise determining if the attempt to contact the recipient is successful, at 806. If it is determined that the attempt was not successful, then the method 800 may continue to determine whether the attempt should be repeated, at 808. In the case that it is determined that the attempt should be repeated, the method 800 may loop back to attempt to contact the recipient at 804. In the case that it is determined that that no further attempt should be made, the method 800 may, in some embodiments, end.

In some embodiments, if the attempt was successful, the method 800 may proceed to select a professional to communicate with the recipient at 810. The method 800 may further comprise prompting the recipient regarding group communications services, at 812. The recipient may be prompted, for example, for information regarding the progress toward a goal and/or the degree of success of various tasks such as a level of compliance of taking a medication, experienced side-effects, reasons for not taking the medication, etc. In some embodiments, the recipient may simply be prompted regarding whether the recipient is aware of the service, enrolled in the service, and/or willing to participate in the service.

The method 800 may comprise determining if the recipient provides a valid response (e.g., to the prompt at 812), at 814. In the case that no valid response was received, the method 800 may proceed to determine if a repeat attempt to contact should be made, at 808. In the case that a valid response was received, the method 800 may proceed to connect the selected professional to the recipient (e.g., establish and/or facilitate a communication session), at 816. The method 800 may proceed to store information descriptive of the recipient, at 818. The method 800 may also or alternatively inform the group coordinator (in the case that the coordinator is not the same as the recipient) that the recipient has received a welcome communication, at 820.

Turning now to FIG. 9, a flow diagram of a method 900 according to some embodiments is shown. In some embodiments, the method 900 may comprise a group communications method or portion thereof, such as a portion of a scheduled group communications method. In some embodiments, the method 900 may comprise a method of communications between a professional and a recipient. According to some embodiments, the method 900 may be implemented, facilitated, and/or performed by or otherwise associated with any of the systems 100, 300 of FIG. 1 and/or FIG. 3 herein. In some embodiments, the method 900 may be associated with the system processes 200, 400, 500 of FIG. 2, FIG. 4, and/or FIG. 5 herein.

The method 900 may, according to some embodiments, begin at “B”. The method 900 may then, for example, comprise scheduling a communication between a recipient and a professional, at 902. The method 900 may also or alternatively comprise attempting to contact the recipient, at 904.

According to some embodiments, the method 900 may comprise determining if the attempt to contact the recipient is successful, at 906. If it is determined that the attempt was not successful, then the method 900 may continue to determine whether the attempt should be repeated, at 908. In the case that it is determined that the attempt should be repeated, the method 900 may loop back to attempt to contact the recipient at 904. In the case that it is determined that that no further attempt should be made, the method 900 may, in some embodiments, end.

In some embodiments, if the attempt was successful, the method 900 may proceed to determine whether the recipient confirms their identity, at 910. In the case that the recipient does not confirm their identity, the method 900 may proceed to determine if the recipient is available, at 912. In the case that the recipient is not available, the method 900 may proceed to leave a message for the recipient, at 914, and/or proceed to end. If the recipient is available and/or if the recipient confirms their identity, then the method 900 may proceed to select a professional to communicate with the recipient, at 916. The method 900 may comprise connecting the selected professional to the recipient, at 918.

In some embodiments, the method 900 may comprise prompting the recipient for data regarding scheduled group communications, at 920. In some embodiments, the method 900 may proceed to store data (such as any data received in response to 920), at 922. The data, for example, may comprise compliance data, progress data, reward data, etc.

### VI. Apparatus

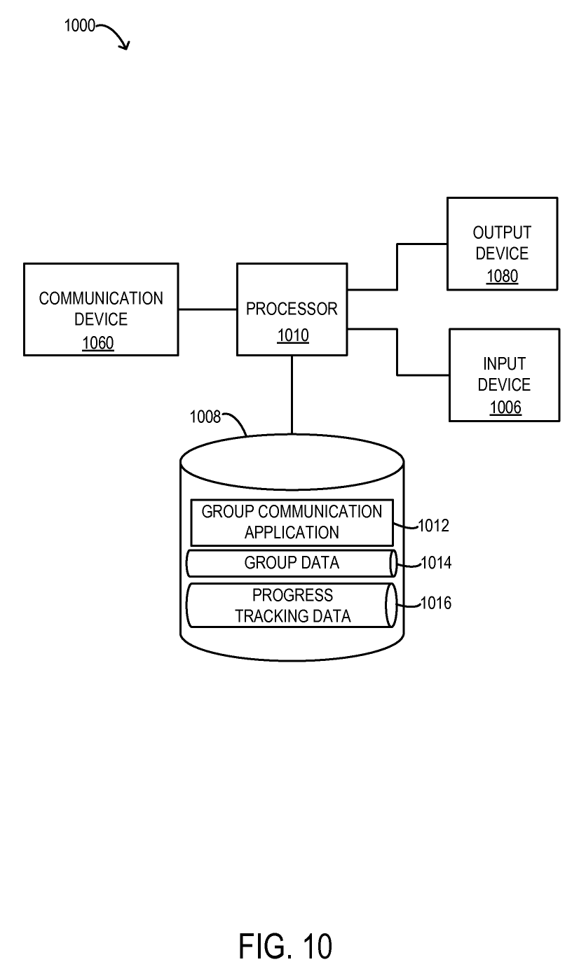

Turning to FIG. 10, a block diagram of an apparatus 1000 according to some embodiments is shown. In some embodiments, the apparatus 1000 may be similar in configuration and/or functionality to any of the coordinator devices 102, 202, the recipient devices 302, 402, 502, and/or the group member devices 104a-n, 204a-n, 304a-n, 404a-n, 504a-n of FIG. 1, FIG. 2, FIG. 3, FIG. 4, and/or FIG. 5 herein. The apparatus 1000 may, for example, execute, process, facilitate, and/or otherwise be associated with any of the system processes 200, 400, 500 of FIG. 2, FIG. 4, and/or FIG. 5, and/or any of the methods 700, 800, 900 described in conjunction with FIG. 7, FIG. 8, and/or FIG. 9 herein. In some embodiments, the apparatus 1000 may comprise an input device 1006, a memory device 1008, a processor 1010, a communication device 1060, and/or an output device 1080. According to some embodiments, any or all of the components 1006, 1008, 1010, 1060, 1080 of the system 1000 may be similar in configuration and/or functionality to any similarly named and/or numbered components described with respect to the systems 100, 300 of FIG. 1 and/or FIG. 3 herein. Fewer or more components and/or various configurations of the components 1006, 1008, 1010, 1060, 1080 may be included in the system 1000 without deviating from the scope of embodiments described herein.

According to some embodiments, the processor 1010 may be or include any type, quantity, and/or configuration of processor that is or becomes known. The processor 1010 may comprise, for example, an Intel® IXP 2800 network processor or an Intel® XEON™ Processor coupled with an Intel® E7501 chipset. In some embodiments, the processor 1010 may comprise multiple inter-connected processors, microprocessors, and/or micro-engines. According to some embodiments, the processor 1010 (and/or the apparatus 1000 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 1000 comprises a server such as a blade server, necessary power may be supplied via a standard AC outlet, power strip, surge protector, and/or Uninterruptible Power Supply (UPS) device.

In some embodiments, the input device 1006 and/or the output device 1080 are communicatively coupled to the processor 1010 (e.g., via wired and/or wireless connections and/or pathways) and they may generally comprise any types or configurations of input and output components and/or devices that are or become known, respectively. The input device 1006 may comprise, for example, a keyboard that allows an operator of the apparatus 1000 to interface with the apparatus 1000 (e.g., by a group coordinator and/or group member, such as to conduct, schedule, and/or otherwise facilitate group communications as described herein). In some embodiments, the input device 1006 may comprise a sensor configured to provide information to the apparatus 1000 and/or the processor 1010. The output device 1080 may, according to some embodiments, comprise a display screen and/or other practicable output component and/or device. The output device 1080 may, for example, provide group communication messages to group members (e.g., via a website) and/or provide messages to support achievement of a goal and/or completion of a task (e.g., via a portable device). According to some embodiments, the input device 1006 and/or the output device 1080 may comprise and/or be embodied in a single device such as a touch-screen monitor or display.

In some embodiments, the communication device 1060 may comprise any type or configuration of communication device that is or becomes known or practicable. The communication device 1060 may, for example, comprise a NIC, a telephonic device, a cellular network device, a router, a hub, a modem, and/or a communications port or cable. The communication device 1060 may, for example, comprise a cellular telephone network transmission device that sends signals indicative of group communications to group members and/or recipients' handheld, mobile, and/or telephone devices. According to some embodiments, the communication device 1060 may also or alternatively be coupled to the processor 1010. In some embodiments, the communication device 1060 may comprise an IR, RF, Bluetooth™, and/or Wi-Fi® network device coupled to facilitate communications between the processor 1010 and another device (such as a support device and/or a reward device as described herein).

The memory device 1008 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM). The memory device 1008 may, according to some embodiments, store a group communications application 1012, group data 1014, and/or progress tracking data 1016.

According to some embodiments, the group communications application 1012 may be utilized to manage group communications as described herein. According to some embodiments, the group communications application 1012 may be operable to cause the processor 1010 to perform various processes and/or methods such as described in accordance with group communication embodiments herein.

Any or all of the exemplary instructions, applications, modules, and data types described herein and other practicable types of data may be stored in any number, type, and/or configuration of memory devices that is or becomes known. The memory device 1008 may, for example, comprise one or more data tables or files, databases, table spaces, registers, and/or other storage structures. In some embodiments, multiple databases and/or storage structures (and/or multiple memory devices 1008) may be utilized to store information associated with the apparatus 1000. According to some embodiments, the memory device 1008 may be incorporated into and/or otherwise coupled to the apparatus 1000 (e.g., as shown) or may simply be accessible to the apparatus 1000 (e.g., externally and/or remotely located and/or situated).

### VII. Additional Embodiments

Additional embodiments may include:
(i) 3^{rd} Party Company Involvement:
   In one embodiment of a Support Group System, one or more 3^{rd} Party Companies may interact with the Support Group System.
      Data Sharing
         As is discussed above, information about Support Group Tasks stored message information may be Such information may be highly useful to a 3^{rd} Party Company. For instance, consider a case where Support Groups are monitoring prescription compliance and reporting reasons for non compliance. The data produced by these groups and stored on the Support Group System may be highly valuable to 3^{rd} party companies who work in the pharmaceutical industry.
            In one example, a Drug Manufacturer may be interested in why people stop taking their drugs.
            In another example, a Pharmacy may be interested in why people stop refilling a prescribed medication.
            In yet another example, an Insurance company may be interested in statistics about how many people are compliant with a prescribed medication regimen.
            In yet another example, a non-profit organization or association (e.g., the FDA) may be interested in knowing what side effects people are reporting as a result of taking a specific medication.
         Types of Information that may stored on the Support Group System and shared with a 3^{rd} Party Company
            Any information processed and stored by the system may be shared with a Third Party Company, including but not limited to:
            Individual Support Group Data
            Size of support Group
            Support Group Purpose
            E.g., Prescription Compliance
            Support Group member Information
            Contact info
            Demographic info
            Relationship to target
            Profile information
            Support Group Candidate Information
            Contact info
            Demographic info
            Relationship to target
            Profile information
            Support Group Target Information
            Contact info
            Demographic info
            Relationship to target
            Profile information
            Health Condition(s)
            Prescribed and or Monitored Medications
            Health History
            Compliance History
            Task Feedback
            E.g., Reasons for not taking a medication
            Task Frequency
            Task Details
            What is the task?
            Support Group System Information
            Aggregated Support Group Data
            3^{rd} Party Companies may receive sets of information about more than one Support group.
            Summary Statistics
            Support Group Data Statistics may be calculated and compiled.
            E.g., what is the compliance rate for a specific drug?
            E.g., How many people report x as the reason to stop taking a medication?
            E.g., what percentage of targets are on more than one medication?
            Data may be Sortable.
            E.g., the company can search and sort information received from the Support Group System
            3^{rd} Party companies may be able to view overview information about multiple Support Groups, but then select specific Support groups to find out more detailed information about individual groups.
            Data may be segmented by cohort
            E.g., compile data for targets on a specific drug.
            E.g., compile data for targets of a specific demographic.
            E.g., compile data for Support groups with a common purpose.
         Anonymous Information
            In some instances, jurisdictional rules and regulations may prevent free sharing of information between a 3^{rd} Party Company and the Support Group System. In such a situation, the Support Group System may be designed such that data is collected and/or shared anonymously
            Personal or identifying information may be stripped out of data aggregated, stored, or shared
            E.g., Contact info
            E.g., Profile information (name, address)
            E.g., Demographic information
      Anonymous intervention
         Some of the concepts discussed in Example 4 describe ways that potential problems can be detected by monitoring information processed and stored by the Support Group System. These same steps and processes can be performed by a 3^{rd} Party Company.
            For example, a Pharmaceutical Company receives information specific to Group Targets who are taking drugs that the company manufactures. It may be in the best interest of the company to monitor that information in order to determine if Group Target is experiencing side effects or symptoms that are dangerous to their health.
         Once a problem has been detected, the company may execute one or more escalation events.
         It should be noted that, as discussed above, part or all of the steps in detecting a problem and employing an escalation event to resolve the problem may be automated. In another example, one or more of these steps may be performed by live employee
            E.g., Software detects a keyword indicating a potential problem in received Task Feedback. The Software automatically sends a message to the Support Group indicating the potential problem and ways to resolve the problem.
            E.g., a human employee is reading Task Feedback, sees a patient is experiencing a side effect that is particularly dangerous when experienced as a result of the Company's medication. The employee may then anonymously contact the Group Coordinator to warn her of the dangers of such a side effect and to advise her how to treat the problem.
      3^{rd} Party Communication with Support Group
         In one embodiment, the Support Group System may provide a 3^{rd} Party Company with the opportunity to communicate with a Support Group.
         Communication channels may be always open
            E.g., a 3^{rd} Party Company can contact the Support Group at any time, and vice versa.
         Communication may be limited
            E.g., a 3^{rd} Party Company can only contact the Support Group X times per y time period, and vice versa.
            E.g., a 3^{rd} Party Company can only contact the Support Group during a specified time period, and vice versa.
         Communication may be conditional
            For Example, a 3^{rd} Party company has the opportunity to contact a Support Group when one or more conditions are met
            E.g., When a patient is non-compliant for 2 or more days in a row
            E.g., When a specific reason for non-compliance is reported
         Communication may be anonymous
            When Contacting a Support Group, The 3^{rd} Party may not be given personal or identifying information
            Communication may flow through the Support Group System to facilitate anonymity
            E.g., Email from 3^{rd} Party sent to Support Group System and then is rerouted to the Support Group
            E.g., an anonymous conference call is set up by the Support Group System
         Examples of Communication
            Emails
            Physical Mailing
            SMS Messages
            Phone Calls
            Indirect contact through another entity (e.g., a doctor or other medical professional);
(ii) Obtaining and Managing Consent:

In many embodiments, the system described herein is contemplated as a management system for a group of people organizing activities to support an individual. As such, information about this individual may be collected, stored on the system, and may be shared among group members, or potentially with other entities, including but not limited to medical professionals, third party partners, government agencies;

Information about this individual may not necessarily be collected or managed directly by the individual. The individual's information may often, for example, be used by the Group Coordinator and associated members. Some tasks managed through the system, as in the example of a Support Group formed for monitoring prescription compliance, may involve storing or transmitting sensitive or private data about the individual;

As such, depending on the type of information, the system may be designed to facilitate and track obtaining the individual's consent to manage all or part of a task via a support group. A number of methods to acquire patient consent may be used:
In one example, the individual may provide consent directly to the system by a variety of means:
   E.g. responding to a message sent by the system to a verified account, such as an email or registered mobile phone number.
   E.g. logging into a website and agreeing to terms and conditions disclosed.
   E.g. Transmitting a form via electronic or physical means, a record of which is stored in the system database.
In another example, the individual may provide consent indirectly by a variety of means:
   E.g. via a Group Member, which includes the Group Coordinator downloads a consent form and obtains permission from the individual.
   E.g. via a Medical Professional, such as a doctor, nurse, or pharmacist, who may obtain appropriate signatures, waivers, and verifications as a unique transaction with the patient, or as part of another transaction
   E.g. via a Third Party, such as a pharmaceutical firm, health insurer, wellness program provider, or marketing partner, where obtaining consent is part of a registration for a program or incentive offered.
   E.g. the individual authorizes another individual to act on their behalf regarding collection, storing and sharing personal data.
In another example, the individual may not provide consent:
   E.g. the task does not involve sharing information that can be considered sensitive or private.
   E.g. some subset of the tasks or message types within a support group task type, such as confirming a caller of the day, does not require consent and may be accessed by some or all entities associated with this support group; and
(iii) Managing Personal Data:
   The system may manage tasks, the display, or the transmission of information, or available features differently depending on the status, type, method, or timing in which consent was obtained. Additionally, the system may manage tasks, display, or the transmission of information differently depending on the entity that is accessing the information.
   Type of access to personal may be defined by one or more entities, e.g. a patient, a group coordinator, a system administrator, or authorized third party.

### VIII. Sample Exemplary Use Cases

Examples of contexts for utilization of embodiments described herein may include:
1. Deciding who to take to an event
2. Coordinating a meeting place
3. Reaching out for advice or support (at a late hour)
4. Figuring out the first person who has the answer to your question
5. Coordinating an impromptu social gathering
6. Reaching out for homework help
7. Coordinating a study group
8. Finding a substitute for work
9. Getting a ride
10. Scoping out the best option to view an event
11. Finding a suitable conversation partner
12. Spreading news or gossip
13. Seeking immediate relationship advice
14. Seeking relationship advice
15. Seeking alternative perspective
16. Seeking company
17. Organizing a group to decide who will call grandma to remind her to take her medications
18. Deciding who will check on someone to help them stay on their workout plan
19. Asking someone to help you in a moment of temptation, e.g. stop me from smoking this cigarette

### IX. Sample Support Group Questions

Examples of questions that may be presented in accordance with embodiments described herein may include:
1. Lauren: xtra tkt for dmb at fenway! Who wants to go?
2. Jen: Sara in town 2nite. dinner @6 anyone? Know a place downtown?
3. Sara: aaaahh! how do u explain thunder to a crying 2 yr old?! Ok 2 call?
4. Les: have mtg in 30 mins. need quick history on the jones account. Hav u wrkd on it b4?
5. Adrien: yo-drinx 2moro? Margaritas outside blackheads afterwork?Weather permitting . . . ”
6. Angela: Didn't understand last night's psych reading, can someone explain?
7. Jordan: Statistics test tomorrow. Study date at 3:30 this afternoon?
8. Jordan: Jane called out sick, need someone to work afternoon shift today. Anyone available?
9. John: where r u. can u pick me up at the mall
10. Ben: we watching the game @ your house?
11. Ariel: did u see the news about obama today?? (decoy to reach a boy)
12. Janna: omg did u hear the latest about Andrea?
13. Gabrielle: i just hung up on mark. Need 2 talk b4 he calls back. help!
14. Jill: confusing vm from Eric. what does it mean???
15. Talia: Asking for a raise 2moro. Advice and support?
16. Leah: bored stuck in traffic. keep me company?

### X. Sample Support Group Processes

A. Scenario 1

An exemplary scenario is presented for illustration of how certain embodiments may be implemented, and may include:
Step 1: Choose a list of friends to send a Support Group to
   Ashley
   Ana
   Nikole
   Jenna
Step 2: Compose a question
   “Just got into a fight with Mark. Really upset—do you have time to talk?”
Step 3: Send your question to the Support Group System Controller.
   To: Ashley; Jenna; Nikole; Ana
   “Just got into a fight with Mark. Really upset—do you have time to talk?”
Step 4: Support Group sends an SMS to everyone on the list.
   GT:Gabrielle: Reply Y,N “Just got into a fight with Mark. Really upset—do you have time to talk?”
Step 5: Anyone who responds Y or N responds to the System Controller.
   12:33:50 pm from Ashley: “Y”
   12:34:01 pm from Ana: “Y; call me in 20 minutes!”
   12:35:21 pm from Nikole: “Y; are you okay? Call me when you can!”
   12:37:21 pm from Jenna: “N; sorry babe. Feel better! I'll call you after work!”
Step 6: The Support Group system receives each response, and merges them into a single report.
   GTR 12:40:00 pm
   Y: Ashley
   Y: Ana [symbol]
   Y: Nikole [symbol]
   N: Jenna
Step 7: Close Support Group request by sending a message to the System Controller.
   “ClzGTS: Send “Thank you! Call you later!”
Step 8: Support Group sends release message to everyone who responded.
   SMS to Ashley; Ana; Nikole; Jenna
   GT:Gabrielle: “Thank you! Call you later!”.

B. Scenario 2

An exemplary scenario is presented for illustration of how certain embodiments may be implemented, and may include:
Step 1: Choose a list of friends to send a Support Group to
   Anat
   Andrea
   Anna
   Brian
   Carrie
   Doug
   Gaby
   Heather
   Jairo
   Jeff
   Michael
   Marcus
   Nathalie
   Peter
   Steven
   Tom
Step 2: Compose a question
   “Sara in town 2nite. dinner @6? Know a place downtown? Need 2 make reservations.”
Step 3: Send your question to the Support Group System Controller.
   To: Anat; Andrea; Anna; Brian; Carrie; Doug; Gaby; Heather; Jairo; Jeff; Michael; Marcus; Nathalie; Peter; Steven; Tom
   “Sara in town 2nite. dinner @6? Know a place downtown? Need 2 make reservations.”
Step 4: Support Group sends an SMS to everyone on the list.
   GT:Jen: Reply Y,N “Sara in town 2nite. dinner @6? Know a place downtown? Need 2make reservations.”
Step 5: Anyone who responds Y or N responds to the System Controller.
   1:42:18 pm from Heather: “N;sending hugs”
   1:42:20 pm from Jairo: “N;but go to sabatellos”
   1:49:32 pm from Andrea: “Y:let's go to Fios.”
   1:49:40 pm from Brian: “Y”
   1:50:08 pm from Gaby: “Y: cu then”
   1:50:10 pm from Anat: “N: Sorry luv.”
   1:50:15 pm from Carrie: “Y: where?”
   1:50:15 pm from Peter: “N”
Step 6: The Support Group system receives each response, and merges them into a single report.
   GTR 12:52:00 pm
   Y: Brian
   Y: Gaby: [symbol]
   Y: Andrea [symbol]
   Y: Carrie: [symbol]
   N: Heather: [symbol]
   N: Jairo: [symbol]
   N: Anat: [symbol]
   N: Peter
   NA: Anna
   NA: Doug
   NA: Jeff
   NA: Michael
   NA: Marcus
   NA: Nathalie
   NA: Steven
   NA: Tom
Step 7: Decide to wait for another update in 5 minutes.
   GTR 12:57:00 pm
   Y: Doug
   N: Anna
   N: Steven
   N: Nathalie: [symbol]
   Y: Brian
   Y: Gaby: [symbol]
   Y: Andrea [symbol]
   Y: Carrie: [symbol]
   N: Heather: [symbol]
   N: Jairo: [symbol]
   N: Anat: [symbol]
   N: Peter
   NA: Anna
   NA: Jeff
   NA: Michael
   NA: Marcus
   NA: Nathalie
   NA: Tom
Step 8: Close Support Group request by sending a message to the System Controller.
   “ClzQ:NoOne:SendY”6@Fios c u there!!“:SendN:“Sorry. next time!:NoSendN:Peter”
Step 9: Support Group sends release message everyone who responded, except Peter, who Jen contacted already off the system.
   SMS to Doug, Brian, Gaby, Andrea, Carrie
   GT:Jen: 6@Fios c u there!!
   SMS to Anna, Steven, Nathalie, Heather, Jairo, Anat
   GT:Jen: 6@Fios c u there!!
Step 10: Support Group sends automatic release message to anyone who responds after the poll is closed.
   SMS to Michael: “GT has already been closed. Thank you!”
   SMS to Tom: “GT has already been closed. Thank you!”
Step 12: Support Group sends messages to Jen, so she can respond personally if needed.

C. Scenario 3

An exemplary scenario is presented for illustration of how certain embodiments may be implemented, and may include:
Step 1: Choose a list of friends to send a Support Group to
   Kim
   Karen
   Deb
   Rachel
   Caleb
   Paula
   Chris
Step 2: Compose a question
   xtra tkt for dmb at fenway!!!!! Who wants to go??
Step 3: Send your question to the Support Group System Controller.
   To: Kim; Karen; Deb; Rachel;Caleb;Paula;Chris
   xtra tkt for dmb at fenway!!!!! Do u wanna go??
Step 4: Support Group sends an SMS to everyone on the list.
   GT:Lauren: Reply Y,N “xtra tkt for dmb at fenway!!!!! Do u wanna go??
Step 5: Anyone who responds Y or N responds to the System Controller.
   12:33:50 pm from Rachel: “N;soooo jealous. Have plans. Wish I could go!”
   12:34:01 pm from Chris: “N”
   12:35:21 pm from Deb: “Y;awesome!!!!luv dmb!!”
   12:37:21 pm from Chris: “Y;where are the seats?”
Step 6: The Support Group system receives each response, and merges them into a single report.
   GTS 12:40:00 pm
   Y: Deb:+Text
   Y: Chris:+Text
   N: Rachel:+Text
   N: Caleb
   NA: Kim
   NA: Karen
   NA: Paula
Step 7: Decide to wait for another update in 5 minutes.
   GTS 12:45:00 pm
   Y: Paula
   Y: Deb:+Text
   Y: Chris:+Text
   N: Rachel:+Text
   N: Caleb
   NA: Kim
   NA: Karen
Step 8: Close Support Group request by sending a message to the System Controller.
   “ClzGTS:Caleb:Send”Thx grrlz!Going with Chris!xoxo”
Step 9: Support Group sends release message everyone who responded but Chris.
   SMS to Deb, Rachel, Paula, Caleb
   GT:Lauren:Thx grrlz!Going with Chris!xoxo
Step 10: Kim responds after the GTR is closed.
   12:52:27 pm from Kim: “Y;seriously? dying 2go!”
Step 11: Support Group sends automatic release message to anyone who responds after the poll is closed.
   SMS to Kim: “GT has already been closed. Thank you!”
Step 12: Support Group sends Kim's message to Lauren, so she can respond personally??

D. Scenario 4

An exemplary scenario is presented for illustration of how certain embodiments may be implemented, and may include:
Step 1: Choose a list of friends to send a Support Group to
   Anna
   Cathy
   Dana
   Julia
   Mom
   Shirley
Step 2: Compose a question
   aaaahh! how do u explain thunder to a crying 2 yr old?!Ok 2 call?
Step 3: Send your question to the Support Group System Controller.
   To: Anna;Cathy;Dana;Julia;Mom
   aaaahh! how do u explain thunder to a crying 2 yr old?!Ok 2 call?
Step 4: Support Group sends an SMS to everyone on the list.
   GT:Sara: Reply Y,N “aaaahh! how do u explain thunder to a crying 2 yr old?!Ok 2 call?”
Step 5: Anyone who responds Y or N responds to the System Controller.
   10:42:18 pm from Anna: “Y;lots of hugs!”
   10:42:50 pm from Julia: “Y;!!tell him it's very loud wind”
   10:42:50 pm from Shirley: “Y!!awwww.I have a funny story 4u!!”
Step 6: The Support Group system receives each response, and merges them into a single report.
   GTS 12:52:00 pm
   Y: Anna: [symbol]
   Y: Julia [symbol]
   Y: Shirley [symbol]
   NA: Cathy
   NA: Dana
   NA: Mom
Step 7: Close Support Group request by sending a message to the System Controller.
   “ClzQ:Shirley:SendNAll:”Thx!He just stopped crying finally!”
Step 8: Support Group sends release message everyone on the list (even if they didn't respond) except Shirley.
   SMS to Anna, Julia, Cathy, Dana, Mom
   GT:Sara: Thx!He just stopped crying finally!!!
Step 9: Support Group sends automatic release message to anyone who (accidentally) responds after the poll is closed.
   SMS to Cathy: “GT has already been closed. Thank you!”
Step 10: Support Group sends messages to Sara, so she can respond personally if needed.

E. Scenario 5

An exemplary scenario is presented for illustration of how certain embodiments may be implemented, and may include:
Step 1: Choose a list of friends to send Support Group to
   Nikita
   Marcus
   Lisa
   Zac
   Shirley
   Jon
Step 2: Compose a question
   “Have mtg in 30 mins. Need quick history on the Jones account. Have u wrkd on it b4?
Step 3: Send your question to the Support Group System Controller.
   “Have mtg in 30 mins. Need quick history on the Jones account. Have u wrkd on it b4?” Nikita; Marcus; Lisa; Zac; Shirley; Jon
Step 4: Support Group sends an SMS to everyone on the list
   “GTS:Jordan: Reply Y,N “Have mtg in 30 mins. Need quick history on the Jones account. Have u wrkd on it b4?”
Step 5: Anyone who responds Y or N responds to the System Controller.
   1:53:02 pm from Nikita: “Y—can call you in 15 minutes!”
   1:53:30 pm from Lisa: “N—Sorry, have to prepare for a meeting!”
   1:53:45 pm from Zac: “N”
   1:54:02 pm from Shirley: “Y—Call me!”
   1:56:52 pm from Jon: N/A
   1:57:06 pm from Marcus: N/A
Step 6: The Support Group system receives each response, and merges them into a single report
   GTS 1:55:00 pm
   Y: Nikita: +Text
   N: Lisa: +Text
   N: Zac
   Y: Shirley: +Text
   N/A: Jon
   N/A: Marcus
Step 7: Decide to wait for another update in 15 seconds
   GTS 1:55:15 pm
   Y: Nikita: +Text
   N: Lisa: +Text
   N: Zac
   Y: Shirley: +Text
   N/A: Jon
   N/A: Marcus
Step 8: Close Support Group request by sending a message to the System Controller.
   “ClzGTS: Shirley: Send “Something came up, I'll call you later”
Step 9: Support Group sends release message to everyone who responded except Nikita.
   SMS to Nikita; Lisa; Zac: “Something came up, I'll call you later”
Step 10: Support Group sends automatic release message to anyone who responds after the poll is closed.
   SMS to Jon; Marcus: “Support Group has already been closed. Thank you.”

F. Scenario 6

An exemplary scenario is presented for illustration of how certain embodiments may be implemented, and may include:
Step 1: Choose a list of friends to send a Support Group to
   Lisa
   Jordan
   Shirley
   Nikita
   Marcus
   Zac
   Evan
   Lindsey
   John
   Jay
Step 2: Compose a question
   “yo-drinx 2moro? Margaritas outside blackheads afterwork?Weather permitting . . . ”
Step 3: Send your question to the Support Group System Controller.
   “yo-drinx 2moro? Margaritas outside blackheads afterwork?Weather permitting . . . ” Lisa; Jordan; Shirley; Nikita;Marcus;Zac;Evan;John; Jay
Step 4: Support Group sends an SMS to everyone on the list.
   “GTS:Adrien: Reply Y,N “”yo-drinx 2moro? Margaritas outside blackheads afterwork?Weather permitting . . . ”
Step 5: Anyone who responds Y or N responds to the System Controller.
   5:53:02 pm from Lisa: “Y”
   5:53:06 pm from Evan: “N”
   5:53:30 pm from Shirley: “Y”
   5:53:45 pm from Jordan: “N—maybe the day after?”
   5:54:52 pm from Zac: “Y—sweet”
   5:56:52 pm from Marcus “Y—I'm so there”
   5:57:01 pm from Nikita “N—wish I could!”
   5:57:38 pm from John “N—maybe next time.”
Step 6: The Support Group system receives each response, and merges them into a single report.
   GTS 6:00:00 pm
   Y: Lisa
   Y: Shirley
   Y: Zac:+Text
   Y:Marcus:+Text
   N: John:+Text
   N: Evan
   N: Jordan:+Text
   N: Nikita:+Text
   N/A:Tim
   N/A: Jay
Step 7: Decide to close Support Group request by sending a message to the System Controller.
   “ClzGTS: To all the Y “Awesome, cu there!”, To all the N “Maybe next time!”
Step 8: Support Group sends release message everyone who responded.
   SMS to Lisa; Shirley; Zac; Marcus: “Awesome, cu there”
   SMS to John; Evan; Jordan; Nikita; Tim; Jay: “Maybe next time!”
Step 9: Support Group sends automatic release message to anyone who responds after the poll is closed.
   SMS to Tim; Jay: “Support Group has already been closed. Thank you!”

G. Scenario 7

An exemplary scenario is presented for illustration of how certain embodiments may be implemented, and may include:
Step 1: Choose a list of friends to send a Support Group to.
   Lisa
   Jordan
   Shirley
   Nikita
   Marcus
   Zac
   Evan
   Tim
Step 2: Compose a question.
   “Didn't understand last night's psych reading, can someone explain?”
Step 3: Send your question to the Support Group System Controller.
   “Didn't understand last nights psych reading, can someone explain?”Lisa; Jordan; Shirley; Nikita;Marcus;Zac;Evan
Step 4: Support Group sends an SMS to everyone on the list.
   “GTS:Angela: Reply Y,N “Didn't understand last nights psych reading, can someone explain?”
Step 5: Anyone who responds Y or N responds to the System Controller.
   9:30:02 am from Lisa: “Y—free at 10:00”
   9:30:08 am from Evan: “Y—sure, it was easy”
   9:30:15 am from Shirley: “N—no time before class, sorry”
   9:30:23 am from Jordan: “Y—was tough, but I think I get it!”
Step 6: The Support Group system receives each response, and merges them into a single report.
   GTS 9:30:30 am
   Y: Lisa:+Text
   Y: Jordan:+Text
   Y: Evan:+Text
   N: Shirley:+Text
   N/A: Zac
   N/A: Marcus
   N/A: Nikita
   N/A: Tim
Step 7: Decide to wait for another update in 30 seconds.
   GTS 9:31:00 am
   Y: Lisa:+Text
   Y: Jordan:+Text
   Y: Evan:+Text
   N: Shirley:+Text
   N: Marcus
   N:Tim
   N/A: Nikita
   N/A: Zac
Step 8: Close Support Group request by sending a message to the System Controller.
   “ClzGTS:To Lisa “great, call u at 10”: Send to all “got help, thx so much!”
Step 9: Support Group sends release message everyone who responded but Jordan.
   SMS to Lisa “Great, call u at 10”
   SMS to Jordan, Shirley, Evan, Marcus, Tim: “got help, thx so much!”
Step 10: Support Group sends automatic release message to anyone who responds after the poll is closed.
   SMS to Nikita; Zac: “Support Group has already been closed. Thank you!”

H. Scenario 8

An exemplary scenario is presented for illustration of how certain embodiments may be implemented, and may include:
Step 1: Choose a list of friends to send Support Group to
   Nikita
   Marcus
   Lisa
   Zac
   Shirley
   Jon
Step 2: Compose a question
   “Jane called out sick, need someone to work afternoon shift today. Anyone available?”
Step 3: Send your question to the Support Group System Controller.
   “Jane called out sick, need someone to work afternoon shift today. Anyone available?” Nikita; Marcus; Lisa; Zac; Shirley; Jon
Step 4: Support Group sends an SMS to everyone on the list
   “GTS:Jordan: Reply Y,N. Jane called out sick, need someone to work afternoon shift today. Anyone available?”
Step 5: Anyone who responds Y or N responds to the System Controller.
   1:53:02 pm from Nikita: “Y”
   1:53:30 pm from Lisa: “N”
   1:53:45 pm from Zac: “Y”
   1:54:02 pm from Shirley: N/A
   1:56:52 pm from Jon: N/A
   1:57:06 pm from Marcus: N/A
Step 6: The Support Group system receives each response, and merges them into a single report
   GTS 1:55:00 pm
      Y: Nikita
      N: Lisa
      Y: Zac
      N/A: Shirley
      N/A: Jon
      N/A: Marcus
Step 7: Decide to wait for another update in 15 seconds
   GTS 1:55:15 pm
      Y: Nikita
      N: Lisa
      Y: Zac
      N: Shirley
      N/A: Jon
      N/A: Marcus
Step 8: Close Support Group request by sending a message to the System Controller.
   “ClzGTS: Nikita: Send “Got the information I needed, thank you!”
Step 9: Support Group sends release message to everyone who responded except Nikita.
   SMS to Zac; Shirley: “Got the information I needed, thank you!”
Step 10: Support Group sends automatic release message to anyone who responds after the poll is closed.
   SMS to Jon; Marcus: “Support Group has already been closed. Thank you.”

I. Scenario 9

An exemplary scenario is presented for illustration of how certain embodiments may be implemented, and may include:
Step 1: Choose a list of friends to send a Support Group to
   Dad
   Mom
   Sis
   Kyle
   Zac
Step 2: Compose a question
   where r u. can u pick me up at the mall
Step 3: Send your question to the Support Group System Controller.
   To: Dad;Mom:Sis:Kyle:Zac
   where r u. can u pick me up at the mall
Step 4: Support Group sends an SMS to everyone on the list.
   GT:Chris: Reply Y,N “where r u. can u pick me up at the mall”
Step 5: Anyone who responds Y or N responds to the System Controller.
   5:42:18 pm from Sis: “N”
   5:42:50 pm from Mom: “N:In a mtg till 6:30”
Step 6: The Support Group system receives each response, and merges them into a single report.
   GTS 5:45:00 pm
   N: Sis
   N: Mom [symbol]
   NA: Dad
   NA: Kyle
   NA: Zac
Step 7: More people respond.
   5:44:18 pm from Kyle: “Y”
   5:44:50 pm from Zac: “Y:on my way”
Step 8: The Support Group system merges them into an updated report.
   GTS 5:48:00 pm
   Y: Kyle
   Y: Zac [symbol]
   N: Sis
   N: Mom [symbol]
   NA: Dad
Step 9: Close Support Group request by sending a message to the System Controller.
   “ClzQ:SendN: ok Ill be home in an hour.”
Step 10: Support Group sends release message everyone on the list (even though Chris txts Zac to say ok he is too lazy to txt more than he needs to, just doesn't want mom to worry.)
   SMS to Kyle, Zac, Sis, Mom, Dad
   GT:Sara: ok Ill be home in an hour.
Step 11: Support Group sends automatic release message to anyone who (accidentally) responds after the poll is closed.
   SMS to Dad: “GT has already been closed. Thank you!”

### XI. Rules of Interpretation

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention that must be present in all embodiments.

Neither the Title (set forth at the beginning of the first page of this patent application) nor the Abstract (set forth at the end of this patent application) is to be taken as limiting in any way the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including the specification, its claims and figures, and anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to allow for distinguishing that particular referenced feature from another feature that is described by the same term or by a similar term. For example, a “first widget” may be so named merely to allow for distinguishing it in one or more claims from a “second widget”, so as to encompass embodiments in which (1) the “first widget” is or is the same as the “second widget” and (2) the “first widget” is different than or is not identical to the “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; (3) does not indicate that either widget ranks above or below any other, as in importance or quality; and (4) does not indicate that the two referenced widgets are not identical or the same widget. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices which are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this patent application and the title of this patent application are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining and the like.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software

A “processor” generally means any one or more microprocessors, CPU devices, computing devices, microcontrollers, digital signal processors, or like devices, as further described herein.

The term “computer-readable medium” refers to any medium that participates in providing data (e.g., instructions or other information) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave, or any other medium from which a computer can read.

The term “computer-readable memory” may generally refer to a subset and/or class of computer-readable medium that does not include transmission media such as waveforms, carrier waves, electromagnetic emissions, etc. (e.g., non-transitory media). Computer-readable memory may typically include physical media upon which data (e.g., instructions or other information) are stored, such as optical or magnetic disks and other persistent memory, DRAM, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, computer hard drives, backup tapes, Universal Serial Bus (USB) memory devices, and the like.

Various forms of computer readable media may be involved in carrying data, including sequences of instructions, to a processor. For example, sequences of instruction (i) may be delivered from RAM to a processor, (ii) may be carried over a wireless transmission medium, and/or (iii) may be formatted according to numerous formats, standards or protocols, such as Bluetooth™, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel® Pentium® or Centrino™ processor, that are adapted to communicate with the computer. Any number and type of machines may be in communication with the computer.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A method, comprising:
receiving, by an electronic controller and from a device operated by a group coordinator, an indication of a request to transmit a message to a group;
distributing, by the electronic controller and in response to the receiving of the indication of the request to transmit the message to the group, the message to the group, wherein the group comprises a plurality of members;
receiving, by the electronic controller, after the distributing of the message to the group, and from the group, a plurality of responses to the message;
generating, by the electronic controller and after the receiving of the plurality of responses to the message, a status report message, wherein the status report message comprises information summarizing the received plurality of responses to the message; and
transmitting, by the electronic controller and to the device operated by the group coordinator, the generated status report message.

2. The method of claim 1, wherein the message distributed to the group comprises an indication of a task that the group coordinator desires at least one of the group members to perform.

3. The method of claim 2, wherein the message distributed to the group is selected from a set of template messages associated with the task.

4. The method of claim 2, further comprising:
generating, by the electronic controller and based at least in part on the task, the message distributed to the group.

5. The method of claim 2, further comprising:
receiving, by the electronic controller, from a member of the group, and after a determination that the task is completed, a response to the message distributed to the group;
generating, by the electronic controller and in response to the post-task receiving of the response to the message distributed to the group, a message indicating that the task is completed; and
transmitting, by the electronic controller and to the member of the group from which the post-task response was received, the generated task-completion.

6. The method of claim 2, wherein the task comprises contacting a patient and reminding the patient to take a scheduled medication.

7. The method of claim 2, wherein the task comprises communicating with the group coordinator.

8. The method of claim 2, further comprising:
determining, by the electronic controller, that one of the group members from which one of the plurality of responses to the message was received is selected to perform the task.

9. The method of claim 8, wherein the determining that the one of the group members from which one of the plurality of responses to the message was received is selected to perform the task, comprises:
receiving, by the electronic controller and from the device operated by the group coordinator, an indication of a selection of the one of the group members.

10. The method of claim 8, wherein the determining that the one of the group members from which one of the plurality of responses to the message was received is selected to perform the task, comprises:
determining, by the electronic controller and based on one or more stored rules, a selection of the one of the group members.

11. The method of claim 8, further comprising:
generating, by the electronic controller and after the determining of the selected group member, a closing message comprising an indication of at least one of: (i) an end of a need for the task to be completed; and (ii) an indication of the selected group member.

12. The method of claim 6, further comprising:
distributing, by the electronic controller and to all group members except the selected group member, the generated closing message.

13. The method of claim 8, further comprising:
transmitting, by the electronic controller, after the determining of the selected group member, and to the selected group member, a task selection message comprising an indication of the selection of the group member to complete the task.

14. The method of claim 13, wherein the task selection message further comprises an instruction for the selected group member to perform the task.

15. The method of claim 8, further comprising:
establishing, by the electronic controller, a communication session between a device operated by the selected group member and the device operated by the group coordinator.

16. The method of claim 8, wherein the receipt of the response to the message from the selected group member comprises a completion of the task.

17. The method of claim 16, wherein the task comprises answering a question in the message.

18. The method of claim 8, further comprising:
receiving, by the electronic controller, a second message from the selected group member.

19. The method of claim 18, wherein the second message comprises information descriptive of a completion of the task.

20. The method of claim 19, further comprising:
forwarding, by the electronic controller, the information indicative of the second message to the device operated by the group coordinator.

21. The method of claim 20, wherein the information indicative of the second message comprises at least one of a summarized and a redacted version of the second message.

23. The method of claim 18, further comprising:
storing, by the electronic controller and in a task progress database, the information descriptive of the completion of the task.

24. The method of claim 1, wherein the request received from the device operated by the group coordinator comprises a request to schedule the message to be distributed to the group on a recurring basis.

25. The method of claim 24, wherein the message comprises a series of different messages.

26. The method of claim 1, wherein the distributing comprises transmitting a plurality of messages in accordance with at least one of a Short Message Service (SMS) and a Multimedia Messaging Service (MMS) protocol.

27. The method of claim 1, wherein the generating of the information summarizing the received plurality of responses to the message, comprises at least one of: (i) tagging the plurality of responses to the message; and (ii) redacting the plurality of responses to the message.

28. The method of claim 1, wherein the generating of the status report message is conducted upon an occurrence of an end of a predetermined time period.

29. The method of claim 1, wherein the generating of the status report message is conducted upon receiving a request for the status report message from the device operated by the group coordinator.

30. A method, comprising:
receiving, by an electronic controller and from a device operated by a group coordinator, an indication of a request to schedule recurring communications between a recipient and a group, wherein the group comprises a plurality of members;
determining, by the electronic controller and in response to the receiving of the indication of the request to schedule recurring communications between the recipient and the group, a schedule defining when each member of the group is responsible for communicating with the recipient;
determining, by the electronic controller and after the determining of the schedule defining when each member of the group is responsible for communicating with the recipient, based on a current time and the schedule, which group member is next responsible for communicating with the recipient;
transmitting, by the electronic controller, in response to the determining of which group member is next responsible for communicating with the recipient, and to the determined responsible group member, a reminder to communicate with the recipient during the next scheduled time; and
determining, by the electronic controller and after the transmitting of the reminder to communicate with the recipient during the next scheduled time, whether the determined responsible group member has communicated with the recipient as scheduled.

31. The method of claim 30, wherein the determining of the schedule defining when each member of the group is responsible for communicating with the recipient, comprises:
receiving, by the electronic controller and from the device operated by the group coordinator, an indication of the schedule.

32. The method of claim 30, wherein the determining of the schedule defining when each member of the group is responsible for communicating with the recipient, comprises:
receiving, by the electronic controller and from the device operated by the group coordinator, an indication of a plurality of times when communications between the recipient and the group are desired; and
assigning, by the electronic controller and after the receiving of the indication of the plurality of times when communications between the recipient and the group are desired, at least one group member to be responsible for communicating with the recipient during each time of the plurality of times when communications between the recipient and the group are desired.

33. The method of claim 30, wherein the recipient comprises a patient and wherein the recurring communications comprise reminders for the patient to take a medication.

34. The method of claim 30, wherein the recipient comprises an electronic device configured to present electronic media and wherein the recurring communications comprise indications of electronic media.

35. The method of claim 34, wherein the recurring communications are conducted utilizing Multimedia Messaging Service (MMS).

36. The method of claim 30, further comprising:
determining, by the electronic controller and in the case that it is determined that the determined responsible group member has communicated with the recipient as scheduled, a reward.

37. The method of claim 36, wherein the reward is provided by a third-party.

38. The method of claim 30, wherein the group coordinator is different than the recipient.

39. The method of claim 30, wherein the determining of whether the determined responsible group member has communicated with the recipient as scheduled, comprises:
receiving, by the electronic controller, and from a device operated by the determined responsible group member, a message comprising information descriptive of a communication between the determined responsible group member and the recipient.

40. The method of claim 39, further comprising:
forwarding, by the electronic controller and to the device operated by the group coordinator, the information indicative of the message received from the device operated by the determined responsible group member.

41. The method of claim 40, wherein information indicative of the message received from the device operated by the determined responsible group member comprises at least one of a summarized and a redacted version of the message received from the device operated by the determined responsible group member.

42. The method of claim 39, further comprising:
storing, by the electronic controller and in a progress-tracking database, the information descriptive of the communication between the determined responsible group member and the recipient.

43. The method of claim 39, further comprising:
triggering, by the electronic controller and based on the information descriptive of the communication between the determined responsible group member and the recipient, an action.

44. The method of claim 43, wherein the action comprises one or more of (i) an initiation of communication with a healthcare professional, (ii) an initiation of a communication to the device operated by the group coordinator, and (iii) an initiation of a communication with the recipient.

45. A non-transitory computer-readable medium storing instructions that when executed by a processor of a mobile device result in:
transmitting, to a remote electronic controller and via a Short Message Service (SMS), an indication of definition of a group of recipients;
transmitting, to the remote electronic controller and via the SMS, a request to distribute an SMS message to the group;
receiving, from the remote electronic controller, an SMS status report message generated by the remote electronic controller, wherein the SMS status report message is based on a plurality of responses received by the remote electronic controller in response to a distribution of the SMS message to the group, and wherein the SMS status report message comprises information summarizing the plurality of responses; and
transmitting, to the remote electronic controller, via the SMS, and in response to the receiving of the SMS status report message, a selection of one of the recipients of the group.
